(19) United States
(12) Patent Application Publication
(10) Pub. No.: US 2021/0142306 A1
(43) Pub. Date: May 13, 2021

(54) TRANSACTION PROCESSING SYSTEM

(71) Applicant: TOSHIBA TEC KABUSHIKI KAISHA, Tokyo (JP)

(72) Inventors: Shigeki NIMIYA, Yokohama Kanagawa (JP); Fumio NAKATSUKASA, Yokohama Kanagawa (JP); Mikio ITO, Ota Tokyo (JP); Kiyomitu YAMAGUCHI, Izunokuni Shizuoka (JP); Tsuyoshi KAWAMOTO, Nerima Tokyo (JP)

(73) Assignee: TOSHIBA TEC KABUSHIKI KAISHA, Tokyo (JP)

(21) Appl. No.: 16/911,217

(22) Filed: Jun. 24, 2020

(30) Foreign Application Priority Data
Nov. 8, 2019 (JP) 2019-203273

(51) Int. Cl. G06Q 20/20; G06Q 30/06; G06Q 20/32; G06Q 20/40; G06F 16/23; G06K 7/14; G06K 7/10; G06F 3/0482

(52) U.S. Cl. CPC G06Q 20/203; G06Q 30/0633; G06Q 20/3276; G06F 3/0482; G06F 16/2379; G06K 7/1413; G06K 7/10722; G06Q 20/407

(57) ABSTRACT

A transaction processing system includes at least one processor including a registering unit and a deleting unit. The at least one processor is configured to register, as purchased commodities, commodities designated by operation in an operation device in a terminal apparatus. The at least one processor is configured to delete, from the purchased commodities: in a first case in which a predetermined operation is performed in the operational device for designating one of the commodities on a list screen, in the display device, the list screen representing a list of the commodities registered as the purchased commodities by the at least one processor, wherein the commodity designated by the operation is deleted from the purchased commodities.

### CROSS-REFERENCE TO RELATED APPLICATION

This application is based upon and claims the benefit of priority from Japanese Patent Application No. 2019-203273, filed in Nov. 8, 2019, the entire contents of which are incorporated herein by reference.

### FIELD

Embodiments described herein relate generally to a transaction processing system.

### BACKGROUND

A transaction processing system that registers content of a transaction according to operation of a terminal apparatus by a customer has been conceived as, for example, a cart POS system or a smartphone POS system.

For example, in the smartphone POS system, a commodity identified by a barcode read by a camera included in a terminal apparatus such as a smartphone is registered as a purchased commodity. Accordingly, a customer only has to perform operation for photographing a barcode concerning a commodity that the customer is about to purchase. A burden on the customer for the operation is not so large.

However, if cancelling purchase of a commodity once registered as a purchased commodity, the customer needs to appropriately perform predetermined operation for the cancellation. This is likely to be a heavy burden for an unaccustomed customer.

Under such circumstances, it has been desired to reduce a burden on a customer relating to operation in cancelling purchase of a commodity once registered as a purchased commodity.

Related art is described in, for example, JP-A-2016-131019.

### DESCRIPTION OF THE DRAWINGS

FIG. 1 is a block diagram illustrating a schematic configuration of a transaction processing system according to at least one embodiment;

FIG. 2 is a block diagram illustrating a main part circuit configuration of a store server illustrated in FIG. 1;

FIG. 3 is a block diagram illustrating a main part circuit configuration of a virtual POS server illustrated in FIG. 1;

FIG. 4 is a block diagram illustrating a main part circuit configuration of a mobile controller illustrated in FIG. 1;

FIG. 5 is a schematic diagram illustrating a main data structure of a data record included in a transaction management database illustrated in FIG. 4;

FIG. 6 is a schematic diagram illustrating a main data structure of a data record included in a registration database illustrated in FIG. 4;

FIG. 7 is a block diagram illustrating a main part circuit configuration of a communication server illustrated in FIG. 1;

FIG. 8 is a block diagram illustrating a main part circuit configuration of a user terminal illustrated in FIG. 1;

FIG. 9 is a flowchart of information processing by a processor illustrated in FIG. 8;

FIG. 10 is a flowchart of the information processing;

FIG. 11 is a flowchart of the information processing;

FIG. 12 is a flowchart of the information processing;

FIG. 13 is a flowchart of the information processing;

FIG. 14 is a flowchart of the information processing;

FIG. 15 is a flowchart of information processing by a processor illustrated in FIG. 4;

FIG. 16 is a flowchart of the information processing;

FIG. 17 is a flowchart of the information processing;

FIG. 18 is a flowchart of the information processing;

FIG. 19 is a diagram illustrating an example of a list screen;

FIG. 20 is a diagram illustrating an example of a registration screen;

FIG. 21 is a diagram illustrating an example of the list screen;

FIG. 22 is a diagram illustrating an example of the list screen;

FIG. 23 is a diagram illustrating an example of a guidance screen;

FIG. 24 is a diagram illustrating an example of a number of items selection screen;

FIG. 25 is a diagram illustrating an example of the number of items selection screen;

FIG. 26 is a diagram illustrating an example of a number of items input screen;

FIG. 27 is a diagram illustrating an example of a deletion screen;

FIG. 28 is a diagram illustrating an example of a confirmation screen;

FIG. 29 is a diagram illustrating an example of a release screen;

FIG. 30 is a diagram illustrating an example of a warning screen; and

FIG. 31 is a diagram illustrating an example of an accounting screen.

### DETAILED DESCRIPTION

An object of at least one embodiment is to provide a transaction processing system that can reduce a burden on a customer relating to operation in cancelling purchase of a commodity once registered as a purchased commodity.

A transaction processing system according to an embodiment includes a terminal apparatus including a display device and an operation device and includes at least one processor including a registering unit and a deleting unit. The at least one processor is configured to register, as purchased commodities, commodities designated by operation in the operation device. The at least one processor is configured to delete, from the purchased commodities: in a first case in which a predetermined operation is performed in the operational device for designating one of the commodities on a list screen, in the display device, the list screen representing a list of the commodities registered as the purchased commodities by the at least one processor, wherein the commodity designated by the operation is deleted from the purchased commodities; in a second case in which operation is performed in the operational device for selecting zero from a number of items list, the number of items list for selecting a number of items concerning one of the commodities registered as the purchased commodity by the at least one processor, the commodity, the number of items of which is selected from the number of items list, or is deleted, from the purchased commodities;

in a third case in which operation is performed in the operational device for inputting zero on an input screen for inputting a numerical value serving as the number of items concerning one of the commodities registered as the purchased commodities by the registering unit, the commodity being one of the number of items of which is input to the input screen.

A transaction processing system in an embodiment is explained below with reference to the drawings.

The transaction processing system in at least one embodiment processes a transaction of commodities in a store that sells, to visiting customers, a plurality of commodities including a commodity requiring confirmation by a store clerk in sales because of circumstances in which, for example, an age limit is applied to purchasers (hereinafter referred to as confirmation required commodity).

FIG. 1 is a block diagram illustrating a schematic configuration of a transaction processing system according to at least one embodiment.

The transaction processing system is configured by communicably connecting a plurality of store systems 100, a relay server 200, and user terminals 300 via a communication network 400.

In FIG. 1, two store systems 100 are illustrated, for example. These store systems 100 are respectively provided in a store A and a store B different from each other that use the transaction processing system. Three or more stores that use the transaction processing system may be present. The store systems 100 are provided in each of the stores. In the following explanation, if it is necessary to distinguish the store systems 100 provided in the stores, the store system 100 provided in the store A is represented as a store system 100A and the store system 100 provided in the store B is represented as a store system 100B.

A company that operates the store A may be the same as or may be different from a company that operates the store B. If a transaction system is used in another store, a company that operates the store may be the same as or may be different from the company that operates the store A or the store B.

The relay server 200 relays data communication between the user terminals 300 and the store systems 100. The relay server 200 provides, for example, a relay function for the data communication as a cloud service via the communication network 400.

The user terminals 300 are terminal apparatuses functioning as user interfaces for customers who do shopping in the stores using the transaction system. The user terminals 300 have a function of wirelessly communicating with the store system 100 and a function of wirelessly communicating with the communication network 400. As the user terminals 300, communication terminals having a data communication function such as smartphones or tablet terminals can be used. The user terminals 300 may be carried by customers or may be lent to the customers in the stores.

As the communication network 400, for example, the Internet, a VPN (virtual private network), a LAN (local area network), a public communication network, and a mobile communication network can be independently used or can be combined and used as appropriate. As the communication network 400, typically, the mobile communication network and the Internet or the VPN are used.

A schematic configuration of the store systems 100 are common. That is, each of the store systems 100 is configured by communicably connecting a store server 1, a virtual POS server 2, a mobile controller 3, a communication server 4, an accounting machine 5, and an access point 6 via an intra-store network 7. However, the store server 1, the virtual POS server 2, the mobile controller 3, the communication server 4, the accounting machine 5, the access point 6, and the intra-communication network 7 only have to be common in a function for realizing operation explained below and do not need to be completely the same. A part of the store systems 100 may include apparatuses not illustrate in FIG. 1.

The store server 1 comprehensively manages a plurality of transactions set as targets of transaction processing realized by the store system 100 as explained below. The store server 1 has, for example, the same functions as functions of an existing POS server.

The virtual POS server 2 performs information processing for registration of purchased commodities, settlement of a price for the purchased commodities, and the like in each of transactions according to a request from the outside. That is, the virtual POS server 2 virtually realizes the functions of the existing POS server. The information processing performed by the virtual POS server 2 is customized to be adapted to a difference in an operation policy of each of the stores. That is, for example, information processing performed by the store server 1 included in the store system 100A and information processing performed by the store server 1 included in the store system 100B are sometimes partially different. The virtual POS server 2 is an example of a transaction processing apparatus.

The mobile controller 3 performs a support for causing the virtual POS server 2 to perform the information processing explained above using the user terminal 300 as a user interface device.

The communication server 4 performs communication processing for the store server 1, the virtual POS server 2, the mobile controller 3, and the accounting machine 5 to exchange data with the relay server 200 and the like via the communication network 400.

The accounting machine 5 performs processing for calculating prices for purchased commodities in each of transactions managed by the virtual POS server 2 and causing a customer to settle the prices. A settlement method that can be used by the accounting machine 5 for the settlement may be all or any part of well-known settlement methods such as cash settlement, credit card settlement, electronic money settlement, point settlement, and code settlement (also called mobile settlement or smartphone settlement). The accounting machine 5 may be operated by either a store clerk or a customer. As the accounting machine 5, for example, a self-service accounting machine used in an existing semi-self-service POS system can be used. The accounting machine 5 may have a function of performing information processing for registering a commodity as a purchased commodity. In this case, as the accounting machine 5, for example, a facing-type POS terminal used in an existing POS system or a self-service POS terminal used in an existing self-service POS system can be used.

The access point 6 performs communication processing for enabling the user terminals 300 to access the intra-store communication network 7 through wireless communication. As the access point 6, for example, a well-known communication device that performs wireless communication according to the IEEE801.11 standard can be used. The access point 6 is set in the store to enable the user terminals 300 to wirelessly communicate with the access point 6 from anywhere in a selling space of the store. Depending on a store size, a plurality of access points 6 are disposed in one store system 100.

As the intra-store communication network 7, the Internet, a VPN, a LAN, a public communication network, a mobile communication network, and the like, for example, can be independently used or can be combined and used as appropriate. However, typically, the intra-store communication network 7 is a LAN.

In the store in which the store system 100 is provided, a two-dimensional code TC1 for check-in is posted near an entrance of the store and a two-dimensional code TC2 for check-out is posted near an exist of the store. The two-dimensional code TC1 represents check-in data for check-in. The two-dimensional code TC2 represents check-out data for check-out. The check-in data and the check-out data are different for each of the stores. Accordingly, if it is necessary to distinguish the two-dimensional codes TC1 and TC2 for the store A and the two-dimensional codes TC1 and TC2 for the store B, the two-dimensional codes TC1 and TC2 for the store A are represented as two-dimensional codes TC1A and TC2A and the two-dimensional codes TC1 and TC2 for the store B are represented as two-dimensional codes TC1B and TC2B.

The check-in data represents, for example, information explained below.

(1) An operation version of the store system 100. For example, check-in data represented by the two-dimensional code TC1A represents an operation version of the store system 100A. Check-in data represented by the two-dimensional code TC1B represents an operation version of the store system 100B.

(2) A company code for identifying a company that operates the store in which the store system 100 is provided. For example, the check-in data represented by the two-dimensional code TC1A represents a company code allocated to a company that operates the store A. The check-in data represented by the two-dimensional code TC1B represents a company code allocated to a company that operates the store B.

(3) A store code for identifying the store in which the store system 100 is provided. For example, the check-in data represented by the two-dimensional code TC1A represents a store code allocated to the store A. The check-in data represented by the two-dimensional code TC1B represents a store code allocated to the store B. The store code may be a store code capable of identifying each of all stores that use the transaction processing system or may be a store code capable of identifying each of a plurality of stores operated by the same company.

(4) A name of the company that operates the store in which the store system 100 is provided. For example, the check-in data represented by the two-dimensional code TC1A represents a name of the company that operates the store A. The check-in data represented by the two-dimensional code TC1B represents a name of the company that operates the store B.

(5) A name of the store in which the store system 100 is provided. For example, the check-in data represented by the two-dimensional code TC1A represents a name of the store A. The check-in data represented by the two-dimensional code TC1B represents a name of the store B.

(6) A flag for distinguishing the two-dimensional code TC1 and the two-dimensional code TC2. The flag in the check-in data is set in a state representing the check-in data. The state is, for example, “1”. The flag is common to all the two-dimensional codes TC1.

(7) An IP address of the communication server 4. For example, the check-in data represented by the two-dimensional code TC1A represents an IP address of the communication server 4 included in the store system 100A. The check-in data represented by the two-dimensional code TC1B represents an IP address of the communication server 4 included in the store system 100B.

(8) A domain name of the relay server 200. The domain name is common to all the two-dimensional codes TC. However, a plurality of relay servers 200 having different domain names one another may be properly used for each of the stores. In this case, the check-in data represented by the two-dimensional code TC1 represents a domain name of the relay server 200 used in a store corresponding to the check-in data.

(9) An address of an electronic receipt server. The electronic receipt server is not included in the transaction processing system illustrated in FIG. 1. The electronic receipt server provides an electronic receipt service via the communication network 400. For example, the check-in data represented by the two-dimensional code TC1A represents an address for accessing, via the communication network 400, the electronic receipt server that provides the electronic receipt service use by the company that operates the store A. The check-in data represented by the two-dimensional code TC1B represents an address for accessing, via the communication network 400, the electronic receipt server that provides the electronic receipt service used by the company that operates the store B. The address may be common to all the two-dimensional codes TC1 or any one of a plurality of addresses may be represented for each of the two-dimensional codes TC1.

(10) A flag indicating which of wireless communication with the access point 6 and wireless communication with the communication network 400 the user terminal 300 should use for data exchange with the store system 100. For example, in the store A, if wireless communication with the access point 6 is used for data exchange between the store system 100A and the user terminal 300, the flag is set to, for example, “1”. For example, in the store B, if wireless communication with the communication network 400 is used for data exchange between the store system 100B and the user terminal 300, the flag is set to, for example, “0”.

(11) An SSID (service set identifier) for identifying the access point 6. For example, the check-in data represented by the two-dimensional code TC1A represents an SSID for identifying the access point 6 included in the store system 100A. The check-in data represented by the two-dimensional code TC1B represents an SSID of the access point 6 included in the store system 100B.

(12) A password for accessing the access point 6. For example, the check-in data represented by the two-dimensional code TC1A represents a password set in the access point 6 included in the store system 100A. The check-in data represented by the two-dimensional code TC1B represents a password set in the access point 6 included in the store system 100B.

(13) An identification number of a security scheme used by the access point 6. As the identification number, for example, “1” is allocated to a WPA2-PSK scheme, “2” is allocated to a WPA-PSK scheme, and “3” is allocated to a WEP scheme. For example, if the access point 6 included in the store system 100A uses the WPA2-PSK scheme as the security scheme, the check-in data represented by the two-dimensional code TC1A represents “1” as the identification number. For example, if the access point 6 included in the store system 100B uses the WPA-PSK scheme as the security scheme, the check-in data represented by the two-dimensional code TC1B represents “2” as the identification number.

(14) A flag for identifying, if the user terminal 300 fails in connection to the relay server 200, whether the failure is regarded as an error or operation is continued without regarding the failure as an error. For example, in the store A, if setting is made to regard, if the user terminal 300 fails in connection to the relay server 200, the failure as an error, the check-in data represented by the two-dimensional code TC1A represents, for example, “1” as the flag. For example, in the store B, if setting is made to continue operation even if the terminal 300 fails in connection to the relay server 200, the check-in data represented by the two-dimensional code TC1B represents, for example, “0” as the flag.

(15) An identification number of a transmission mode concerning a status of the user terminal 300. As the transmission mode, there are, for example, a first mode, a second mode, and a third mode. As the identification number of the transmission mode, for example, “1” is allocated to a first mode, “2” is allocated to a second mode, and “3” is allocated to a third mode. In the first mode, the status of the user terminal 300 is transmitted to the relay server 200. In the second mode, the status of the user terminal 300 is transmitted to the store system 100. In the third mode, the status of the user terminal 300 is not transmitted. For example, in the store A, if the first mode is applied as the transmission mode, the check-in data represented by the two-dimensional code TC1A represents “1” as the identification number. For example, in the store B, if the second mode is applied as the transmission mode, the check-in data represented by the two-dimensional code TC1B represents “2” as the identification number.

(16) An identification number of a transmission mode concerning a log file in which log data of the user terminal 300 is accumulated, for example. As the transmission mode, there are, for example, a first mode, a second mode, a third mode, and a fourth mode. As the identification number of the transmission mode, for example “1” is allocated to the first mode, “2” is allocated to the second mode, “3” is allocated to the third mode, and “4” is allocated to the fourth mode. In the first mode, the log file is transmitted to only the relay server 200. In the second mode, the log file is transmitted to only the store system 100. In the third mode, the log file is transmitted to both of the store system 100 and the relay server 200. In the fourth mode, the log file in not transmitted. For example, in the store A, if the first mode is applied as the transmission mode, the check-in data represented by the two-dimensional code TC1A represents “1” as the identification number. For example, in the store B, if the second mode is applied as the transmission mode, the check-in data represented by the two-dimensional code TC1B represents “2” as the identification number.

(17) A host name or an IP address used when the log file is transmitted to the relay server 200 via the communication network 400 with an FTP (file transfer protocol).

(18) A user name used when the log file is transmitted to the relay server 200 via the communication network 400 with the FTP.

(19) A password used when the log file is transmitted to the relay server 200 via the communication network 400 with the FTP.

(20) A pass name of the log file transmitted to the relay server 200 via the communication network 400 with the FTP.

(21) A flag for identifying whether to delete a check digit of a UPC (universal product cord), which is a type of a commodity code. For example, in the store A, in operation for not deleting the check digit, the check-in data represented by the two-dimensional code TC1A represents, for example, “1” as the flag. For example, in the store B, in operation for deleting the check digit, the check-in data represented by the two-dimensional code TC1B represents, for example, “0” as the flag.

(22) A time until a camera screen is automatically transitioned in the user terminal 300. The check-in data represented by the two-dimensional code TC1A represents, as the time, a time set in advance concerning the store A. The check-in data represented by the two-dimensional code TC1B represents, as the time, a time set in advance concerning the store B.

(23) A timeout time in communication performed by the user terminal 300 with the store system 100 via the access point 6. The check-in data represented by the two-dimensional code TC1A represents, as the timeout time, a time set in advance concerning the store A. The check-in data represented by the two-dimensional code TC1B represents, as the timeout time, a time set in advance concerning the store B.

(24) The number of times retry is permitted if communication between the user terminal 300 and the store system 100 via the access point 6 times out. The check-in data represented by the two-dimensional code TC1A represents, as the number of times, the number of times set in advance concerning the store A. The check-in data represented by the two-dimensional code TC1B represents, as the number of times, the number of times set in advance concerning the store B.

(25) A timeout time in communication performed by the user terminal 300 with the store system 100 via the relay server 200. The check-in data represented by the two-dimensional code TC1A represents, as the timeout time, a time set in advance concerning the store A. The check-in data represented by the two-dimensional code TC1B represents, as the timeout time, a time set in advance concerning the store B.

(26) The number of times retry is permitted if communication between the user terminal 300 and the store system 100 via the relay server 200 times out. The check-in data represented by the two-dimensional code TC1A represents, as the number of times, the number of times set in advance concerning the store A. The check-in data represented by the two-dimensional code TC1B represents, as the number of times, the number of times set in advance concerning the store B.

(27) Authentication data used in authentication processing for authenticating a declaration of a confirmation end concerning a transaction targeting commodities for which confirmation by a store clerk is necessary. The check-in data represented by the two-dimensional code TC1A represents authentication data set in advance concerning the store A. The check-in data represented by the two-dimensional code TC1B represents authentication data set in advance concerning the store B. It is preferable that the authentication data is decided to be different in each of the stores. However, the same authentication data may be set in different stores.

(28) Data for identifying an operation mode of the store system 100. For example, if the store system 100A is set in a normal mode for normally operating the transaction processing system, the check-in data represented by the two-dimensional code TC1A represents, for example, “1” as the data. For example, if the store system 100B is set in a demonstration mode for demonstratively operating the transaction processing system, the check-in data represented by the two-dimensional code TC1B represents, for example, “2” as the data.

(29) Data for identifying a mode of data transfer to the accounting machine 5. For example, if the store system 100A is set in a mode for requesting, from the accounting machine 5, the mobile controller 3 to perform data transfer, the check-in data represented by the two-dimensional code TC1A represents, for example, “1” as the data. For example, if the store system 100B is set in a mode for performing data transfer from the mobile controller 3 to the accounting machine 5 without a request from the accounting machine 5, the check-in data represented by the two-dimensional code TC1B represents, for example, “2” as the data.

(30) A flag representing whether to permit settlement in a code settlement scheme by operation in the user terminal 300. For example, in the store A, if the code settlement is permitted, the check-in data represented by the two-dimensional code TC1A represents, for example, “1” as the flag. For example, in the store B, if the code settlement is not permitted, the check-in data represented by the two-dimensional code TC1B represents “0” as the flag.

(31) A flag for identifying whether to permit registration in the user terminal 300 of a commodity for which an age limit for purchasers is decided (herein after referred to as age limited commodity). For example, in the store A, if the registration of the age limited commodity in the user terminal 300 is permitted, the check-in data represented by the two-dimensional code TC1A represents, for example, “1” as the flag. For example, in the store B, if the code settlement is not permitted, the check-in data represented by the two-dimensional code TC1B represents for example, “0” as the flag.

(32) Data for identifying an input mode for a member code of a point member. For example, if the store system 100A is set in a mode for manually inputting the member code, the check-in data represented by the two-dimensional code TC1A represents, for example, “1” as the data. For example, if the store system 100B is set in a mode for inputting the member code by reading a barcode, the check-in data represented by the two-dimensional code TC1B represents, for example, “2” as the data.

(33) A flag for identifying whether confirmation by a store clerk is necessary in an input of the member code if the mode for manually inputting the member code of the point member is set. For example, if the confirmation is necessary in the store A, the check-in data represented by the two-dimensional code TCA represents, for example, “1” as the flag. For example, if the confirmation is unnecessary in the store B, the check-in data represented by the two-dimensional code TC1B represents, for example, “0” as the flag.

(34) A threshold for checking battery residual power of the user terminal 300 during check-in. The threshold is set for each of the stores or each of the companies. For example, if the company that operates the store A decides the threshold as “20%”, the check-in data represented by the two-dimensional code TC1A represents, for example, “20” as the threshold. For example, if the store B decides the threshold as “25%”, the check-in data represented by the two-dimensional code TC1B represents, for example, “25” as the threshold.

The examples of the information represented by the check-in data are as explained above. However, the check-in data may not include a part of the various kinds of information explained above. The check-in data may represent information different from the various kinds of information explained above.

FIG. 2 is a block diagram illustrating a main part circuit configuration of the store server 1, as an example.

The store server 1 includes a processor 11, a main memory 12, an auxiliary storage unit 13, a communication interface 14, and a transmission line 15. The processor 11, the main memory 12, the auxiliary storage unit 13, and the communication interface 14 are communicably connected via the transmission line 15. The processor 11, the main memory 12, and the auxiliary storage unit 13 are connected by the transmission line 15, whereby a computer for controlling the store server 1 is arranged.

The processor 11 is equivalent to a central part of the computer. The processor 11 executes, according to information processing programs such as an operating system and application programs, information processing for realizing various functions of the store server 1. The processor 11 is, for example, a CPU (central processing unit).

The main memory 12 is equivalent to a main storage portion of the computer. The main memory 12 includes a nonvolatile memory region and a volatile memory region. The main memory 12 stores the information processing programs in the nonvolatile memory region. The main memory 12 sometimes stores, in the nonvolatile or volatile memory region, data necessary for the processor 11 in executing the information processing. The main memory 12 uses the volatile memory region as a work area where data is rewritten as appropriate by the processor 11. The nonvolatile memory region is, for example, a ROM (read only memory). The volatile memory region is, for example, a RAM (random access memory).

The auxiliary storage unit 13 is equivalent to an auxiliary storage portion of the computer. As the auxiliary storage unit 13, for example, a storage unit including a well-known storage device such as an EEPROM (electric erasable programmable read-only memory), a HDD (hard disc drive), or an SSD (solid state drive) can be used. The auxiliary storage unit 13 saves data used by the processor 11 in performing various kinds of processing, data created by the processing in the processor 11, or the like. The auxiliary storage unit 13 sometimes stores the information processing programs.

The communication interface 14 performs data communication between the communication interface 14 and the units connected to the intra-store communication network 7 according to a predetermined communication program. As the communication interface 14, for example, a well-known communication device for LAN can be applied.

The transmission line 15 includes an address bus, a data bus, and a control signal line and transmits data and control signals exchanged among the connected units.

The auxiliary storage unit 13 stores a store management application AP11, which is one of the information processing programs. The store management application AP11 is an application program and is described about information processing for realizing the functions of the store server 1. The store management application AP11 may be a separate application created to be adapted to a store operation policy of each of the stores or each of the companies that operate the stores. For example, if management methods for sales data are different between the store A and the store B, the store management application AP11 used in the store system 100A is described about information processing for management of sales data adapted to the management method for sales data in the store A and the store management application AP11 used in the store system 100B is described about information processing for management of sales data adapted to the management method for the sales data in the store B.

A part of a storage region of the auxiliary storage unit 13 is used as a database group DB11. The database group DB11 includes a plurality of databases for various kinds of information management. One of the databases included in the database group DB11 is a commodity database for managing commodities sold in the store. The commodity database is a set of data records correlated with management target commodities. The data records of the commodity database include data concerning correlated commodities such as a commodity code, a price, and a commodity name. The commodity code is an identification code decided to identify the commodities for each of SKUs (stock keeping units). For example, a JAN (Japanese article number) code is used. The commodity name is a name decided to allow a human to easily distinguish a commodity. The price is an amount paid for sales of a commodity.

One of the databases included in the database group DB11 is a user database for managing users of the store. The user database is a set of data records correlated with customers registered as users. The data records of the user database include data concerning the correlated customers such as user codes and attribute information for specifying the users. The user codes are unique identification codes decided for each of the customers in order to individually identify the users. The attribute information could include a name, sex, age, an address, and a telephone number. The data records of the user database sometimes include settlement information declared by the users. The settlement information is a credit number, a code settlement ID (identifier), and the like. If a plurality of settlement methods are selectable, the settlement information sometimes includes settlement method codes for identifying the settlement methods. In the case of a store that provides a point service, the settlement information sometimes includes an ID of the point service and the number of owned points.

Besides, the database group DB 11 could include various databases managed by a POS server in the existing POS system. It may be decided for each of the stores what kinds of databases the database group DB 11 includes or what kinds of data in what kinds of structure the databases include.

FIG. 3 is a block diagram illustrating a main part circuit configuration of the virtual POS server 2.

The virtual POS server 2 includes a processor 21, a main memory 22, an auxiliary storage unit 23, a communication interface 24, and a transmission line 25. The processor 21, the main memory 22, the auxiliary storage unit 23, and the communication interface 24 are communicably connected via the transmission line 25. The processor 21, the main memory 22, and the auxiliary storage unit 23 are connected by the transmission line 25, whereby a computer for controlling the virtual POS server 2 is configured. Overviews of functions of the processor 21, the main memory 22, the auxiliary storage unit 23, the communication interface 24, and the transmission line 25 are equivalent to the overviews of the functions of the processor 11, the main memory 12, the auxiliary storage unit 13, the communication interface 14, and the transmission line 15. Therefore, explanation of the overviews of the functions is omitted.

However, the auxiliary storage unit 23 stores a virtual POS application AP21 instead of the store management application AP11. The virtual POS application AP21 is an application program and is described about information processing for realizing functions of the virtual POS server 2. The virtual POS application AP21 may be a separate application created to be adapted to a store operation policy of each of the stores or each of the companies that operate the stores. For example, in the store A, if a discount service not performed in the store B is performed, the virtual POS application AP21 used in the store system 100A is described about information processing for realizing the discount service. The virtual POS application AP21 used in the store system 100B is not described about the information processing for realizing the discount service.

A part of the storage region of the auxiliary storage unit 23 is used as a transaction database DB21 instead of the database group DB11. The transaction database DB21 is a set of data records correlated with a transaction with a customer shopping in the store. The data records of the transaction database DB21 include transaction codes and unique identification codes concerning commodities registered as purchased commodities. The transaction codes are unique identification codes set for each of the transactions in order to identify the individual transactions. The commodity data represents a commodity code, a commodity name, a prices, the number of items, and the like. The structure of the transaction database DB21 may be individually decided to be adapted to a store operation policy of each of the stores or each of the companies that operate the stores.

FIG. 4 is a block diagram illustrating a main part circuit configuration of the mobile controller 3.

The mobile controller 3 includes a processor 31, a main memory 32, an auxiliary storage unit 33, a communication interface 34, and a transmission line 35. The processor 31, the main memory 32, the auxiliary storage unit 33, and the communication interface 34 are communicably connected via the transmission line 35. The processor 31, the main memory 32, and the auxiliary storage unit 33 are connected by the transmission line 35, whereby a computer for controlling the mobile controller 3 is configured. Overviews of functions of the processor 31, the main memory 32, the auxiliary storage unit 33, the communication interface 34, and the transmission line 35 are equivalent to the overviews of the functions of the processor 11, the main memory 12, the auxiliary storage unit 13, the communication interface 14, and the transmission line 15. Therefore, explanation of the overviews of the functions is omitted.

However, the auxiliary storage unit 33 stores a registration support application AP31 instead of the store management application AP11. The registration support application AP31 is an application program and is described about information processing explained below for supporting registration of purchased commodities. The registration support application AP31 is common to the store systems 100. However, various settings for the information processing based on the registration support application AP31 may be customized for each of the store systems 100.

A part of a storage region of the auxiliary storage unit 23 is used as a transaction management database DB31 and a registration database DB32 instead of the database group DB11. The structures of the transaction management database DB31 and the registration database DB32 are common to the store systems 100.

FIG. 5 is a schematic diagram illustrating main data structure of a data record DR1 included in the transaction management database DB31.

The transaction management database DB31 is a set of data records DR1 correlated with the user terminals 300 used by customers in the store. Accordingly, if one customer is present in the store, the transaction management database DB31 includes one data record DR1. If no customer is present in the store, the transaction management database DB31 does not include the data record DR1. The data record DR1 includes fields F11, F12, F13, and F14.

In the field F11, a terminal code for identifying the correlated user terminal 300 from the other user terminals 300 is set. As the terminal code, for example, a unique identification code set for each of the communication terminals for identifying the individual communication terminals used as the user terminal 300 can be used. Alternatively, as the terminal code, for example, an identification code set in a smartphone POS application explained below when the smartphone POS application is installed in the user terminal 300 can be used. In the field F12, a member code for identifying a customer using the correlated user terminal 300 from the other customers is set, for example. In the field F13, a transaction code of a transaction performed using the correlated user terminal 300 is set. In the field F14, a confirmation requirement flag for identifying whether a confirmation required commodity is included in commodities registered as purchased commodities using the correlated user terminal 300 is set. In this embodiment, if the confirmation requirement flag is “1”, the confirmation requirement flag represents that a confirmation required commodity is included. The data record DR1 may include another field in which data other than data set in the fields F11 to F15 is set. In other words, the confirmation requirement flag represents whether confirmation by a store clerk is necessary.

FIG. 6 is a schematic diagram illustrating main data structure of a data record DR2 included in the registration database DB32.

The registration database DB32 is a set of data records DR2 correlated with a transaction of a customer shopping in the store. The data record DR2 includes fields F21 and F22. The data record DR1 could include fields F23, F24.

In the field F21, a transaction code of the correlated transaction is set. The transaction code is the same as a transaction code set in the field F12 of the data record DR1 correlated with the user terminal 300 used in the correlated transaction. In the field F22, registration data concerning commodity registration attempted concerning the correlated transaction is set. The registration data is explained below.

If registration of two or more purchased commodities is attempted concerning the correlated transaction, the field F23 and the subsequent fields are included in the data record DR2. The same registration data as the registration data set in the field F12 is set in the field F23 and the subsequent fields.

FIG. 7 is a block diagram illustrating a main part circuit configuration of the communication server 4.

The communication server 4 includes a processor 41, a main memory 42, an auxiliary storage unit 43, a communication interface 44, a communication unit 45, and a transmission line 46. The processor 41, the main memory 42, the auxiliary storage unit 43, the communication interface 44, and the communication unit 45 are communicable connected via the transmission line 46. The processor 41, the main memory 42, and the auxiliary storage unit 43 are connected by the transmission line 46, whereby a computer for controlling the communication server 4 is configured. Overviews of functions of the processor 41, the main memory 42, the auxiliary storage unit 43, the communication interface 44, and the transmission line 46 are equivalent to the overviews of the functions of the processor 11, the main memory 12, the auxiliary storage unit 13, the communication interface 14, and the transmission line 15. Therefore, explanation of the overviews of the functions is omitted.

The communication unit 45 performs communication processing for data communication via the communication network 400. As the communication unit 45, for example, a well-known Internet connection device can be applied.

The auxiliary storage unit 43 stores a communication processing application AP41 instead of the store management application AP11. The communication processing application AP41 is an application program and is described about information processing for communicating with the relay server 200 via the communication network 400 in order to enable data exchange between the mobile controller 3 and the user terminal 300. The communication processing application AP 41 is common to the store systems 100. However, various settings for the information processing based on the communication processing application AP41 may be customized for each of the store systems 100.

FIG. 8 is a block diagram illustrating a main part configuration of the user terminal 300.

The user terminal 300 includes a processor 301, a main memory 302, an auxiliary storage unit 303, a touch panel 304, a camera 305, a wireless communication unit 306, a mobile communication unit 307, and a transmission line 308. The processor 301, the main memory 302, the auxiliary storage unit 303, the touch panel 304, the camera 305, and the mobile communication unit 307 are communicably connected via the transmission line 308. The processor 301, the main memory 302, and the auxiliary storage unit 303 are connected by the transmission line 308, whereby a computer for controlling the user terminal 300 is configured. Overviews of functions of the processor 301, the main memory 302, the auxiliary storage unit 303, and the transmission line 308 are equivalent to the overviews of the functions of the processor 11, the main memory 12, the auxiliary storage unit 13, the communication interface 14, and the transmission line 15. Therefore, explanation of the overviews of the functions is omitted.

The touch panel 304 functions as an operation device and a display device of the user terminal 300.

The camera 305 includes an optical system and an image sensor and generates, with the image sensor, image data representing an image in a visual field formed by the optical system.

The wireless communication unit 306 exchanges data between the wireless communication unit 306 and the access point 6 through wireless communication conforming to a wireless communication protocol. As the wireless communication unit 306, for example, a well-known communication device conforming to the IEEE802.11 standard can be used.

The mobile communication unit 307 is an interface of data communication via the communication network 400. As the mobile communication unit 307, for example, a well-known communication device for performing data communication via a mobile communication network can be used.

The auxiliary storage unit 303 stores a smartphone POS application AP301, which is one of the information processing programs. The smartphone POS application AP301 is an application program and is described about information processing explained below for causing the user terminal 300 to function as a user interface of the store system 100. The smartphone POS application AP301 is used in common in a plurality of user terminals 300.

As hardware of the store server 1, the virtual POS server 2, or the mobile controller 3, for example, a general-purpose server apparatus can be used. In general, transfer of the store server 1, the virtual POS server 2, or the mobile controller 3 is performed in a state in which the store management application AP11, the virtual POS application AP21, or the registration support application AP31 is stored in the auxiliary storage unit 13, 23, or 33 and the database group DB11, the transaction database DB21, or the transaction management database DB31 and the registration database DB32 are not stored in the auxiliary storage units 13, 23, or 33. However, the hardware in a state in which the store management application AP11, the virtual POS application AP21, or the registration support application AP31 are not stored in the auxiliary storage unit 13, 23, or 33 or a state in which an application program of the same type and another version is stored in the auxiliary storage unit 13, 23, or 33 and the store management application AP11, the virtual POS application AP21, or the registration support application AP31 may be individually transferred. The store management application AP11, the virtual POS application AP21, or the registration support application AP31 is written in the auxiliary storage unit 13, 23, or 33 according to operation by any operator, whereby the store server 1, the virtual POS server 2, or the mobile controller 3 may be configured. The transfer of the store management application AP11, the virtual POS application AP21, or the registration support application AP31 can be performed by recording the store management application AP11, the virtual POS application AP21, or the registration support application AP31 in a removable recording medium such as a magnetic disk, a magneto-optical disk, an optical disk, or a semiconductor memory or can be performed by communication via a network. The processor 11, 21, or 31 executes the information processing based on the store management application AP11, the virtual POS application AP21, or the registration support application AP31, whereby the transaction database DB21 or the transaction management DB31 and the registration database DB32 are configured in the auxiliary storage unit 13, 23, or 33. The store management application AP11 and at least a part of the databases included in the database group DB11 may be stored in the main memory 12. The virtual POS application AP21 and at least a part of the transaction database DB21 may be stored in the main memory 22. The registration support application AP31 and at least a part of the transaction management database DB31 and the registration database DB32 may be stored in the main memory 32.

The operation of the transaction processing system configured as explained above is explained. Contents of various kinds of processing explained below are examples. A change of the order of a part of the processing, omission of a part of the processing, addition of other kinds of processing, and the like are possible as appropriate. For example, in the following explanation, explanation about a part of the processing is omitted in order to clearly explain characteristic operations in this embodiment. For example, when some error occurs, processing for coping with the error is sometimes performed. However, description is omitted about a part of such processing.

A service provided to customers by the operation of the transaction processing system explained below is referred to as smartphone POS service.

The user terminal 300 exchanges data with the store system 100 in order to use the smartphone POS service. It is determined according to a state of a flag included in check-in data which of the wireless communication with the access point 6 and the wireless communication with the communication network 400 is used for communication for the exchange of the data. However, in the following explanation, for simplification of explanation, only the wireless communication with the access point 6 is used. It is determined according to a state of a flag included in check-in data which of the mode for requesting, from the accounting machine 5, the mobile controller 3 to perform data transfer and the mode for performing data transfer from the mobile controller 3 to the accounting machine 5 without a request from the accounting machine 5 is used to perform the data transfer from the virtual POS server 2 to the accounting machine 5 in order to cause the accounting machine 5 to perform accounting. However, in the following explanation, for simplification of explanation, it is assumed that the mode for requesting, from the accounting machine 5, the mobile controller 3 to perform data transfer is fixedly used.

In order to use the smartphone POS service, a customer installs the registration support application AP31 in a smartphone or the like carried by the user and enables the smartphone or the like to be used as the user terminal 300. Alternatively, for example, the customer borrows, in the store, the user terminal 300 configured by installing the registration support application AP31 in a tablet terminal or the like. The customer carries the user terminal 300 in a state in which the information processing based on the registration support application AP31 is started and enters any store in which the store system 100 is provided.

In the user terminal 300, the processor 301 executes, based on the registration support application AP31, information processing illustrated in FIGS. 9, 10, 11, 13, and 14.

First, in ACT 101 in FIG. 9, the processor 301 causes the touch panel 304 to display a main menu screen. The main menu screen is a screen for receiving designation of any one of several kinds of processing that should be performed based on the registration support application AP31. A plurality of GUI (graphical user interface) elements including a GUI element for designating a shopping start are arranged on the main menu screen. The GUI elements are, for example, softkeys.

In ACT 102, the processor 301 confirms whether the shopping start is designated. If failing in confirming the designation, the processor 301 determines NO and proceeds to ACT 103.

In ACT 103, the processor 301 confirms whether designation other than the designation of the shopping start is performed. If failing in confirming the designation, the processor 301 determines NO and returns to ACT 102.

In this way, in ACT 102 and ACT 103, the processor 301 waits for some designation to be performed on the main menu screen. If the designation other than the designation of the shopping start is performed, the processor 301 determines YES in ACT 103 and proceeds to designated processing. Explanation about the processing by the processor 301 in this case is omitted.

If entering the store and starting shopping, the customer performs predetermined operation for designating the shopping start on the main menu screen.

If the operation for designating the shopping start is detected on, for example, the touch panel 304, the processor 301 determines YES in ACT 102 and proceeds to ACT 104.

In ACT 104, the processor 301 causes the touch panel 304 to display a scan screen for check-in. The scan screen for check-in is a screen for urging the customer to read the two-dimensional code TC1 for check-in. For example, the processor 301 starts the camera 305, superimposes, on an image thereby obtained by the camera 305, a character message for urging the customer to read the two-dimensional code TC1 and a line indicating a guide for a position above which the two-dimensional code TC1 should be held, and generates a scan screen.

If the scan screen is displayed on the touch panel 304, the customer directs the camera 305 to the two-dimensional code TC1 such that the two-dimensional code TC1 posted near the entrance of the store is reflected on the scan screen.

In ACT 105, the processor 301 waits for a two-dimensional code to be read. At this time, the processor 301 repeatedly analyzes images obtained by the camera 305 and attempts to read the two-dimensional code. The two-dimensional code reading may be performed as processing based on the smartphone POS application AP301 or may be performed as processing based on another application program for two-dimensional code reading. If succeeding in reading the two-dimensional code, the processor 301 determines YES and proceeds to ACT 106.

In ACT 106, the processor 301 confirms whether data represented by the read two-dimensional code is check-in data. If the data is not the check-in data, the processor 301 determines NO and returns to ACT 105. At this time, the processor 301 may cause the touch panel 304 to display a screen for notifying the customer that a wrong two-dimensional code is read.

If succeeding in confirming that the data represented by the read two-dimensional code is the check-in data, the processor 301 determines YES in ACT 106 and proceeds to ACT 107.

In ACT 107, the processor 301 saves the read check-in data in the main memory 302 or the auxiliary storage unit 303.

ACT 108, the processor 301 requests the mobile controller 3 to perform check-in. Specifically, the processor 301 establishes, based on data represented by the check-in data, wireless communication between the wireless communication unit 306 and the access point 6. For example, if the camera 305 is directed to the two-dimensional code TC1A by the customer in the store A, the processor 301 establishes, based on the check-in data represented by the two-dimensional code TC1A, wireless communication with the access point 6 provided in the store system 100A. The processor 301 transmits request data for requesting check-in to the mobile controller 3 via the wireless communication with the access point 6. If the wireless communication with the access point 6 provided in the store system 100A is established as explained above, the request data is transmitted to the mobile controller 3 provided in the store system 100A via the access point 6 and the intra-store communication network 7 provided in the store system 100A. The processor 301 includes, in the request data for requesting check-in, identification data for identifying the request for the check-in and a terminal code. If the customer is a registered user of the smartphone POS system and has a member code, the processor 301 includes the member code in the request data as well. The member code is stored by, for example, the auxiliary storage unit 303 of the user terminal 300. The processor 301 may include, for example, other data such as data for authenticating the customer in the request data.

Various requests from the user terminal 300 to the mobile controller 3 explained below are realized by, as explained above, transmitting request data including identification data for identifying reasons for the requests from the user terminal 300 to the mobile controller 3 via the access point 6 and the intra-store communication network 7.

In the mobile controller 3, if the request data for requesting check-in is received by the communication interface 34, the processor 31 starts information processing concerning a transaction with the customer about to check in.

FIGS. 15, 16, 17, and 18 are flowcharts of the information processing by the processor 31.

The processor 31 starts the information processing every time the request data for requesting check-in is received by the communication interface 34. If information processing started based on another request is already executed, the processor 31 starts new information processing in parallel to the information processing. That is, the processor 31 sometimes executes a plurality of kinds of information processing respectively targeting the plurality of user terminals 300. In the following explanation, if the “user terminal 300” is simply referred to, the “user terminal 300” indicates the user terminal 300 set as a target of the information processing by the processor 31.

In ACT 201 in FIG. 15, the processor 31 performs check-in processing. For example, the processor 31 requests the virtual POS server 2 to start a transaction and receives a notification of a transaction code. The processor 31 adds a new data record DR1, in which the terminal code included in the request data is set in the field F11, to the transaction management database DB31. If a member code is included in the request data, the processor 31 sets the member code in the field F12 of the new data record DR1. The processor 31 sets the notified transaction code in the field F13 of the new data record DR1. The processor 31 sets “0” in the field F14 of the new data record DR1 as a confirmation requirement flag, for example. Consequently, management of the transaction performed using the user terminal 300, which requests check-in, is started.

In the virtual POS server 2, if a start of a transaction is requested from the mobile controller 3, the processor 21 determines a transaction code according to a predetermined rule and correlates registration processing for a purchased commodity with the transaction code and starts the registration processing. The processor 21 notifies the determined transaction code to the mobile controller 3.

In ACT 202, the processor 31 confirms whether the check-in processing is normally completed. If the check-in processing is not successfully normally completed because of some abnormality, the processor 31 determines NO and proceeds to ACT 203.

In ACT 203, the processor 31 notifies an error to the user terminal 300. For example, the processor 31 transmits notification data for the error notification to the user terminal 300 via the intra-store communication network 7 and the access point 6. The processor 31 includes, in the notification data, identification data for identifying the notification of the error. The processor 31 may include, in the notification data, an error code representing a cause of the error.

As explained above, various notifications from the mobile controller 3 to the user terminal 300 explained below are realized by transmitting the notification data including the identification data for identifying the cause of the notification from the mobile controller 3 to the user terminal 300 via the intra-store communication network 7 and the access point 6.

On the other hand, if the check-in processing is successfully normally completed, the processor 31 determines YES in ACT 202 and proceeds to ACT 204.

In ACT 204, the processor 31 notifies check-incompletion to the user terminal 300. For example, the processor 31 transmits notification data for notification of the check-in completion to the user terminal 300 via the intra-store communication network 7 and the access point 6. The processor 31 includes, in the notification data, identification data for identifying the notification for the check-in completion.

In the user terminal 300, after requesting the check-in in ACT 108 in FIG. 9, the processor 301 proceeds to Act 109.

In ACT 109, the processor 301 confirms whether the check-in completion is notified. If failing in confirming the notification, the processor 301 determines NO and proceeds to ACT 110.

In ACT 110, the processor 301 confirms whether an error of the check-in is notified. If failing in confirming the notification, the processor 301 determines NO and returns to ACT 109.

In this way, in ACT 109 and ACT 110, the processor 301 waits for the completion or the error of the check-in to be notified. If the notification data for the notification of the error is received by the wireless communication unit 306, the processor 301 determines YES in ACT 110 and proceeds to ACT 111.

In ACT 111, the processor 301 causes the touch panel 304 to display an error screen. The error screen is a screen decided to inform the customer that the check-in cannot be performed. If display cancellation of the error screen is instructed by, for example, operation of a GUI element displayed in the error screen, the processor 301 returns to ACT 101.

On the other hand, for example, if the notification data for the notification of the check-in completion is received by the wireless communication unit 306, the processor 301 determines YES in ACT 109 and proceeds to ACT 112 in FIG. 10.

In ACT 112, the processor 301 causes the touch panel 304 to display a list screen. The list screen is a screen on which a list of registered purchased commodities is displayed.

FIG. 19 is a diagram illustrating an example of a list screen SC1.

The list screen SC1 includes display areas AR11 and AR12 and buttons BU11, BU12, and BU13. The display area AR11 represents a total number of purchased commodities and a total amount of prices of the purchased commodities. The display area AR12 represents a list of the purchased commodities. The button BU11 is a softkey for the customer to declare that the customer cancels all of the purchased commodities and stops the shopping. The button BU12 is a softkey for the customer to declare that the customer starts scan of a commodity to be registered as a purchased commodity. The button BU13 is a softkey for the customer to declare that the customer starts accounting.

FIG. 19 illustrates the list screen SC1 in a state in which registration of the purchased commodities is not performed. Accordingly, “0” is displayed in the display area AR11 as both of the total number and the total amount. Nothing is displayed in the display area AR12.

In ACT 113 in FIG. 10, the processor 301 confirms whether a scan start for the commodity is designated. If failing in confirming the designation, the processor 301 determines NO and proceeds to ACT 114.

In ACT 114, the processor 301 confirms whether the customer touches a number of items area in the list screen SC1. If failing in confirming operation of the touch, the processor 301 determines NO and proceeds to ACT 115.

In ACT 115, the processor 301 confirms whether a display area of a commodity name in the list screen SC1 is left-flicked. If failing in confirming operation of the left-flick, the processor 301 determines NO and proceeds to ACT 116.

In ACT 116, the processor 301 confirms whether a stop of the shopping is designated. If failing in confirming the designation, the processor 301 determines NO and proceeds to ACT 117.

In ACT 117, the processor 301 confirms whether a start of accounting is designated. If failing in confirming the designation, the processor 301 determines NO and returns to ACT 113.

In this way, in ACT 113 to ACT 117, the processor 301 waits for any one of the scan start, the quantity, the stop, and the accounting start to be designated.

If the customer registers a commodity as a purchased commodity, the customer designates a scan start with predetermined operation for, for example, touching the button BU12 on the list screen SC1. According to the designation, the processor 301 determines YES in ACT 113 and proceeds to ACT 118.

In ACT 118, the processor 301 causes the touch panel 304 to display a registration screen. The registration screen is a screen for urging the customer to read a barcode representing a commodity code of the commodity to be register as the purchased commodity.

FIG. 20 is a diagram illustrating an example of a registration screen SC2.

The registration screen SC2 includes a display area AR21, a message ME21, and a button BU21. An image obtained by the camera 305 is displayed in the display area AR21. The message ME21 is a character message for urging the customer to read a barcode of a commodity. The button BU21 is a softkey for the customer to declare that the customer stops scan of a commodity code.

For example, the processor 301 starts the camera 305, superimposes, on an image thereby obtained by the camera 305, a line representing a range of the display area AR21 and an image representing the message ME21 and the button BU21, and generates the registration screen SC2.

In ACT 119 in FIG. 10, the processor 301 confirms whether the barcode is successfully read. At this time, the processor 301 analyzes the image obtained by the camera 305 and attempts to read the barcode. The barcode reading may be performed as processing based on the smartphone POS application AP301 or may be performed as processing based on another application for barcode reading. If failing in reading the barcode, the processor 301 determines NO and proceeds to ACT 120.

In ACT 120, the processor 301 confirms whether a stop of the scan is designated. If failing in confirming the designation, the processor 301 determines NO and returns to Act 119.

In this way, in ACT 119 and ACT 120, the processor 301 waits for the barcode to be successfully read or the scan stop to be designated.

If desiring to return to the list screen without performing the scan of this time, the customer designates the scan stop with predetermined operation for, for example, touching the button BU21. According to the designation, the processor 301 determines YES in ACT 120 and returns to ACT 112.

If the registration screen is displayed on the touch panel 304, the customer directs the camera 305 to the commodity to be registered as the purchased commodity such that the barcode displayed on the commodity is reflected in the display area AR21. According to the directing of the camera 305, the processor 301 determines YES in ACT 119 and proceeds to ACT 121.

In ACT 121, the processor 301 requests the mobile controller 3 to perform registration. The processor 301 includes, in request data to be transmitted, data represented by the read barcode (hereinafter referred to as barcode data).

In the mobile controller 3, after performing the notification of the check-in completion in ACT 204 in FIG. 15, the processor 31 proceeds to ACT 205.

In ACT 205, the processor 31 confirms whether registration is requested. If failing in confirming the request, the processor 31 determines NO and proceeds to ACT 206.

In ACT 206, the processor 301 confirms whether a quantity change is requested. If failing in confirming the request, the processor 31 determines NO and proceeds to ACT 207.

In ACT 207, the processor 31 confirms whether deletion of a purchased commodity is requested. If failing in confirming the request, the processor 31 determines NO and proceeds to ACT 208.

In ACT 208, the processor 31 confirms whether cancellation of a purchased commodity is requested. If failing in confirming the request, the processor 31 determines NO and proceeds to ACT 209.

In ACT 209, the processor 31 confirms whether accounting is requested. If failing in confirming the request, the processor 31 determines NO and returns to ACT 205.

In this way, in ACT 205 to ACT 209, the processor 31 waits for any one of the registration, the quantity change, the deletion, the cancellation, and the accounting to be requested. As explained above, if the registration is requested from the user terminal 300, the processor 31 determines YES in ACT 205 and proceeds to ACT 210 in FIG. 16.

In ACT 210, the processor 31 transfers the request for the registration to the virtual POS server 2 together with a notification of a transaction code of a transaction set as a processing target. At this time, the processor 31 may directly transfer, to the virtual POS server 2, request data transmitted from the user terminal 300 or may transmit the request data after conversion by some processing to the virtual POS server 2. However, the processor 31 notifies, to the virtual POS server 2, barcode data included in the request data transmitted from the user terminal 300.

In the virtual POS server 2, the processor 21 regards the barcode data included in the request data transmitted from the mobile controller 3 as barcode data read by a barcode scanner included in an existing POS terminal and attempts registration of purchased commodities with the same processing as processing by the existing POS terminal. However, a barcode different from a barcode represented by a commodity code used in the virtual POS server 2 is sometimes displayed on a commodity. Therefore, the barcode data included in the request data sometimes does not represent the commodity code used in the virtual POS server 2. In such a case, the processor 21 cannot perform the registration of the purchased commodities and regards this as an error. In this way, the processor 21 performs the registration of the purchased commodities based on regular barcode reading. The processor 21 executes the information processing based on the virtual POS application AP21 in this way, whereby the computer including the processor 21 as the central part functions as a registering unit. The processor 21 manages the purchased commodities using the transaction database DB21.

The processor 21 transmits a result data representing a result of such processing to the mobile controller 3. If the registration of the purchased commodities is correctly performed, the processor 21 includes, in the result data, identification data for identifying a notification of regular registration and commodity codes, commodity names, and prices of the registered commodities. If regarding the failure of the registration as the error, the processor 21 includes, in the result data, identification data for identifying the notification of the error and the barcode data sent by the registration request.

In the mobile controller 3, after transferring the registration request in ACT 210, the processor 31 proceeds to ACT 211.

In ACT 211, the processor 31 acquires the result data transmitted from the virtual POS server 2 as explained above. The processor 31 saves the acquired result data in the main memory 32 or the auxiliary storage unit 33.

In ACT 212, the processor 31 updates the registration database DB32 based on the result data. The update of the registration database DB32 is performed, for example, as explained below.

Case 1: The identification data indicates the notification of the regular registration and the registration data including the notified commodity code is not included in the data record DR2 correlated with the transaction set as the processing target.

In this case, the processor 31 adds a new field next to the last field already present in the data record DR2 correlated with the transaction set as the processing target and adds new registration data in the field. The processor 31 includes, in the new registration data, the notified commodity code, an error flag set to “0” representing that an error does not occur, the notified commodity names and prices, the number of items set to “1”, and a cancellation flag set to “0” representing that the purchased commodity is not cancelled. Consequently, the registration data added in this case has structure illustrated on the upper right side of FIG. 6.

Case 2: The identification data indicates the registration of the regular registration and the registration data including the notified commodity code is included in the data record DR2 correlated with the transaction set as the processing target but the cancellation flag of the registration data is “1” representing that the purchased commodity is cancelled.

In this case, the processor 31 performs processing in the same manner as in the case 1 explained above.

Case 3: The identification data indicates the notification of the regular notification and the registration data including the notified commodity code is included in the data record DR2 correlated with the transaction set as the processing target and the cancellation flag of the registration data is “0”.

In this case, the processor 31 rewrites a value of the number of items included in the registration data, which includes the notified commodity code and in which the cancellation flag is “0”, to a value incremented by one.

Case 4: The identification data indicates the notification of the error.

In this case, the processor 31 adds a new field next to the last field already present in the data record DR2 correlated with the transaction set as the processing target and adds new registration data in the field. The processor 31 includes, in the new registration data, the notified barcode data and the error flag set to “1” representing the error. Consequently, the registration data added in this case has structure illustrated on the lower right side of FIG. 6.

By being updated by the processor 31 in this way, the registration database DB32 represents a list of purchased commodities registered in the virtual POS server 2 and, in addition to this, records the barcode reading regarded as the error.

The processor 31 may, for example, save the barcode data sent by the registration request in the main memory 32 or the auxiliary storage unit 33 and, in the case 4, include the saved barcode data in the registration data. In this case, in the virtual POS server 2, the processor 21 may not include the barcode data in the result data. The processor 31 may extract a commodity code from the saved barcode data and perform the processing of the case 1 to the case 3 based on the commodity code. The processor 31 may acquire a commodity name and a price from the store server 1 or the like based on the commodity code.

In ACT 213, the processor 31 confirms whether the registration of this time is regularly performed. If the registration is the regular registration, the processor 31 determines YES and proceeds to ACT 214.

In ACT 214, concerning the data record DR1 correlated with the transaction set as the processing target in the transaction management database DB31, the processor 31 confirms whether the confirmation requirement flag set in the field F14 of the data record DR1 is “1”. If the confirmation requirement flag is not “1”, the processor 31 determines NO and proceeds to ACT 215.

In ACT 215, the processor 31 confirms whether the purchased commodity registered this time is a confirmation required commodity. If the purchased commodity is not the confirmation required commodity, the processor 31 determines NO and proceeds to ACT 216. If determining NO in ACT 213 because the registration of this time is regarded as an error and if determining YES in ACT 214 because the confirmation requirement flag is “1”, the processor 31 also proceeds to ACT 216.

In ACT 216, the processor 31 instructs the user terminal 300 to display the list screen. For example, the processor 31 transmits instruction data, which includes identification data for identifying the display instruction for the list screen, to the user terminal 300 via the intra-store communication network 7 and the access point 6. The processor 31 includes, in the instruction data, the commodity code, the commodity name, the price, and the number of items included in the data record DR2 correlated with the transaction set as the processing target in the registration database DB32. If the registration of this time is regarded as an error, the processor 31 includes, in the instruction data, error data representing to that effect. Thereafter, the processor 31 returns to the waiting state in ACT 205 to ACT 209 in FIG. 15.

Various instructions from the mobile controller 3 to the user terminal 300 explained below are realized by transmitting the instruction data including the identification data for identifying the reason for the instruction from the mobile controller 3 to the user terminal 300 via the intra-store communication network 7 and the access point 6 as explained above.

On the other hand, if determining YES in ACT 215 because the purchased commodity is the confirmation required commodity, the processor 31 proceeds to ACT 217. That is, if the regularly registered commodity is the confirmation required commodity and the confirmation requirement flag is “0”, the processor 31 proceeds to ACT 217.

In ACT 217, concerning the data record DR1 correlated with the transaction set as the processing target in the transaction management database DB31, the processor 31 rewrites the confirmation requirement flag set in the field F14 of the data record DR1 to “1”.

In ACT 218, the processor 31 instructs the user terminal 300 to display a guidance screen. The processor 31 includes, in instruction data for instructing the display of the guidance screen, the commodity code, the commodity name, the price, and the number of items included in the data record DR2 correlated with the transaction set as the processing target in the registration database DB32. Thereafter, the processor 31 returns to the waiting state in ACT 205 to ACT 209 in FIG. 15.

In the user terminal 300, after requesting the registration in ACT 121 in FIG. 10, the processor 301 proceeds to ACT 122 in FIG. 11.

In ACT 122, the processor 301 confirms whether the display of the guidance screen is instructed. If failing in confirming the instruction, the processor 301 determines NO and proceeds to ACT 123.

In ACT 123, the processor 301 confirms whether the display of the list screen is instructed. If failing in confirming the instruction, the processor 301 determines NO and returns to ACT 122.

In this way, in ACT 122 and ACT 123, the processor 301 waits for the display instruction for the guidance screen or the list screen. If the display of the list screen is instructed from the mobile controller 3 as explained above, the processor 301 determines YES in ACT 123, returns to ACT 112 in FIG. 10, and causes the touch panel 304 to display the list screen SC1 again. At this time, the processor 301 forms the list screen SC1 as a screen showing the commodity name, the price, and the number of items of the purchased commodity included in the instruction data.

FIG. 21 is a diagram illustrating an example of the list screen SC1 in a state in which purchased commodities are registered.

The list screen SC1 illustrated in FIG. 21 is an example in which a commodity, a commodity name of which is “AAA”, a price of which is 120 yen, and the number of items of which is one, a commodity, a commodity name of which is “BBB”, a price of which is 98 yen, and the number of items of which is two, and a commodity, a commodity name of which is “CCC”, a price of which is 1,024 yen, and the number of items of which is one, are registered as purchased commodities. All of the commodities are not confirmation required commodities. On the list screen SC1 illustrated in FIG. 21, the commodity names, the prices, and the numbers of items concerning these registered commodities are displayed in the display area AR12. Numerical values displayed in number of items areas AR31 provided to correspond to the commodity names represent the numbers of items. In the display area AR11, “4” is displayed as a total number and “1, 340” is displayed as a total amount. Areas surrounded by broken lines on the left side of the commodity names represent areas for displaying icons. The broken lines representing the areas are not actually displayed on the list screen SC1.

FIG. 22 is a diagram illustrating an example of the list screen SC1 in a state in which purchased commodities are registered.

The list screen SC1 illustrated in FIG. 22 is an example in which the commodity, the commodity name of which is “AAA”, the price of which is 120 yen, and the number of items of which is one, the commodity, the commodity name of which is “BBB” the price of which is 98 yen, and the number of items of which is two, the commodity, the commodity name of which is “CCC”, the price of which is 1,024 yen, and the number of items of which is one, and a commodity, a commodity name of which is “DDD”, a price of which is 380 yen, and the number of items of which is one, are registered as purchased commodities. The commodity, the commodity name of which is “DDD”, is a confirmation required commodity. On the list screen SC1 illustrated in FIG. 22, the commodity names, the prices, and the numbers of items concerning these registered commodities are displayed in the display area AR12. “5” is displayed as a total number and “1,720” is displayed as a total amount in the display area AR11. An icon IC11 representing that the commodity is a commodity with an age limit for purchasers is displayed beside the commodity name “DDD”.

On the other hand, if the display of the guidance screen is instructed from the mobile controller 3, the processor 301 determines YES in ACT 122 in FIG. 11 and proceeds to ACT 124.

In ACT 124, the processor 301 causes the touch panel 304 to display a guidance screen. The guidance screen is a screen for informing the customer that confirmation by a store clerk is necessary during accounting.

FIG. 23 is a diagram illustrating an example of a guidance screen SC3.

The guidance screen SC3 is a screen obtained by superimposing and displaying a window WI31 on the list screen SC1. The window WI31 includes a message ME31 and a button BU31. The message ME31 is a character message representing that confirmation by a store clerk is necessary during accounting. The button BU31 is a softkey for the customer to declare that the guidance on the guidance screen SC3 is confirmed. The processor 301 generates the list screen SC1 representing the commodity name, the price, and the number of items of the purchased commodity included in the instruction data and superimposes the window WI31 on the list screen SC1 to generate the guidance screen SC3.

If confirming the guidance on the guidance screen SC3, with predetermined operation for, for example, touching the button BU31 on the guidance screen SC3, the customer declares that the customer confirms the guidance. According to the declaration, the processor 301 returns from ACT 124 in FIG. 11 to ACT 112 in FIG. 10 and causes the touch panel 304 to display the list screen SC1 again. If an elapsed time in a state in which the guidance screen SC3 is displayed reaches a predetermined time, the processor 301 may return from ACT 124 to ACT 112.

If the customer touches any one of the number of items areas AR32 on the list screen SC1 and the touch is detected by the touch panel 304, the processor 301 determines YES in ACT 114 in FIG. 10 and proceeds to ACT 125 in FIG. 12. The commodity associated with the touched number of items area AR32 is hereinafter referred to as target commodity.

In ACT 125, the processor 301 causes the touch panel 304 to display a number of items selection screen. The number of items selection screen is a screen for the customer to select the number of items of the target commodity.

FIG. 24 is a diagram illustrating an example of a number of items selection screen SC4.

The number of items selection screen SC4 includes a display area AR41, buttons BU41 and BU42, and a number of items list LI41 instead of the display area AR12 on the list screen SC1. As in the display area AR12, a list of purchased commodities is displayed in the display area AR41. However, the display area AR41 is narrower than the display area AR12 because of display of the buttons BU41 and BU42 and the number of items list LI41. The button BU41 may be a softkey for the customer to declare that the selection of the number of items is completed. The button BU42 may be a softkey for the customer to declare that the selection of the number of items is cancelled. The number of items list LI41 is a list of numerical values for the customer to select the number of items of the target commodity.

The number of items selection screen SC4 illustrated in FIG. 24 is an example in which any one of the number of items areas AR32 is touched on the list screen SC1 in the state illustrated in FIG. 22.

Only a part of the number of items list LI41 is displayed on the number of items selection screen SC4. In FIG. 24, the top side of the number of items list LI41 is displayed and a state in which “1” is selected as the number of items is displayed. The processor 301 changes, according to flick operation in the up-down direction on the number of items list LI41, a portion displayed on the number of items selection screen SC4 in the number of items list LI41.

FIG. 25 is a diagram illustrating the number of items selection screen SC4 in a state in which the end side of the number of items list LI41 is displayed.

FIG. 25 illustrates a state in which only a display portion of the number of items list LI41 on the number of items selection screen SC4 in the state illustrated in FIG. 24 is differentiated. The number of items list LI41 in FIG. 24 represents a state in which the number of items equal to or larger than ten is selected.

The customer sets, with flick operation on the number of items list LI41, the number of items list LI41 in a state in which the number of items to be purchased of the target commodity is selected and then touches the button BU41. At this time, if deleing the target commodity, the customer sets the number of items list LI41 in a state in which zero is selected, if changing the number of items of the target commodity to any one of one to nine, the customer sets the number of items list LI41 in a state in which the number of items after the change is selected, and, if changing the number of items of the target commodity to ten or more, the customer sets the number of items list LI41 in a state in which the number of items equal to or larger than ten is selected. If cancelling the selection of the number of items, the user touches the button BU42.

After displaying the number of items selection screen SC4 in ACT 125 in FIG. 13, the processor 301 proceeds to ACT 126.

In ACT 126, the processor 301 confirms whether the number of items is selected. If failing in confirming that the number of items is selected, the processor 301 determines NO and proceeds to ACT 127.

In ACT 127, the processor 301 confirms whether return is designated. If failing in confirming the designation, the processor 301 determines NO and returns to ACT 126.

In this way, in ACT 126 and ACT 127, the processor 301 waits for the number of items to be selected or the return to be designated.

If the button BU42 is touched in order to cancel the designation of the number of items as explained above, the processor 301 determines YES in ACT 127, returns to ACT 112 in FIG. 10, and causes the touch panel 304 to display the list screen SC1 again. In this case, since the number of items of the target commodity is not changed, the processor 301 causes the touch panel 304 to display, again, the list screen SC1 in the same state as the list screen SC1 displayed before the number of items selection screen SC4 is displayed.

On the other hand, if the button BU41 is touched in order to select the number of items as explained above, the processor 301 determines YES in ACT 126 and proceeds to ACT 128.

In ACT 128, the processor 301 confirms whether “ten or more” is selected. If “ten or more” is selected, the processor 301 determines YES and proceeds to ACT 129.

In ACT 129, the processor 301 causes the touch panel 304 to display a number of items input screen. The number of items input screen is a screen for the customer to input the number of items of the target commodity.

As explained above, if tap operation for designating one of the number of items areas AR32 associated on the list screen SC1 with the commodity registered as the registered commodity is performed on the touch panel 304 functioning as the operation device, the processor 301 causes the touch panel 304 functioning as the display device to display the number of items list LI41 for designating shift to a numerical value input in addition to selection of the number of items concerning the commodity associated with the designated number of items area AR32. Further, if the shift to the number of items input is designated in the number of items list LI41, the processor 301 causes the display device to display a number of items input screen SC5 for inputting the number of items. The processor 301 executes the information processing based on the smartphone POS application AP301 in this way, whereby the computer including the processor 301 as the central part functions as a control unit.

FIG. 26 is a diagram illustrating an example of the number of items input screen SC5.

The number of items input screen SC5 includes a tenkey TK51 instead of the buttons BU41 and BU42 and the number of items list LI41 on the number of items selection screen SC4 and displays a window WI51 over the display area AR41 on the number of items selection screen SC4. The ten key TK51 is a softkey group for inputting a numerical value. The window WI51 includes a display area AR51 and buttons BU51 and BU52. The display area AR51 is an area for displaying a numerical value being input. The button BU51 is a softkey for the customer to declare that the input of the number of items is completed. The button BU52 is a softkey for the customer to declare that the input of the number of items is cancelled.

The number of items input screen SC5 illustrated in FIG. 26 is an example in which “ten or more” is selected on the number of items selection screen SC4 in the state illustrated in FIG. 25.

The customer displays the number of items of the target commodity in the display area AR51 with operation on the tenkey TK51 and then touches the button BU51. At this time, if deleting the target commodity, the customer inputs “0” and, if changing the number of items of the target commodity, the customer inputs the number of items after the change. If cancelling the input of the number of items, the customer touches the button BU52.

After displaying the number of items input screen SC5 in ACT 129 in FIG. 13, the processor 301 proceeds to ACT 130.

In ACT 130, the processor 301 confirms whether the number of items is input. If failing in confirming that the number of items is input, the processor 301 determines NO and proceeds to ACT 131.

In ACT 131, the processor 301 confirms whether return is designated. If failing in confirming the designation, the processor 301 determines NO and returns to ACT 130.

In this way, in ACT 130 and ACT 131, the processor 301 waits for the number of items to be input or return to be designated.

If the button BU52 is touched in order to cancel the input of the number of items as explained above, the processor 301 determines YES in ACT 131, returns to ACT 112 in FIG. 10, and causes the touch panel 304 to display the list screen SC1 again. In this case, since the number of items of the target commodity is not changed, the processor 301 causes the touch panel 304 to display, again, the list screen SC1 in the same state as the state in which the list screen SC1 is displayed before the number of items selection screen SC4 is displayed in ACT 125.

On the other hand, if the button BU51 is touched in order to input the number of items as explained above, the processor 301 determines YES in ACT 130 and proceeds to ACT 132. If the number of items less than ten is selected on the number of items selection screen SC4, the processor 301 determines NO in ACT 128 and proceeds to ACT 132 passing ACT 129 to ACT 131.

In ACT 132, the processor 301 confirms whether the number of items selected on the number of items selection screen SC4 or the number of items input on the number of items input screen SC5 is zero. If the number of items is not zero, the processor 301 determines NO and proceeds to ACT 133.

In ACT 133, the processor 301 requests the mobile controller 3 to change a quantity. The processor 301 includes, in request data to be transmitted, specifying data for specifying a commodity, the number of items of which is designated, and the designated numbers. The specifying data may be a commodity code or may be data with which purchased commodities can be specified by only the mobile controller 3 such as numbers for identifying the purchased commodities in a list of the purchased commodities. If the commodity code is used as the specifying code, the processor 31 includes commodity codes concerning the purchased commodities in the instruction data for instructing the display of the list screen or instruction data for instructing the display of the guidance screen.

In the mobile controller 3, if the quantity change is requested from the user terminal 300 as explained above, the processor 31 determines YES in ACT 206 in FIG. 15 and proceeds to ACT 219 in FIG. 16.

In ACT 219, the processor 31 transfers the request for the quantity change to the virtual POS server 2 together with a notification of the transaction code of the transaction set as the processing target. At this time, the processor 31 may directly transfer, to the virtual POS server 2, the request data transmitted from the user terminal 300 or may transmit the request data after conversion by some processing to the virtual POS server 2. However, the processor 31 notifies, to the virtual POS server 2, the number of items included in the request data transmitted from the user terminal 300. If the specifying data included in the request data is not the commodity code, the processor 31 replaces the specifying data with the commodity code.

In the virtual POS server 2, the processor 21 regards the number of items included in the request data transmitted from the mobile controller 3 as the number of items input by the input device included in the existing POS terminal and changes the number of items of a purchased commodity with the same processing as processing by the existing POS terminal. The processor 21 transmits the commodity code of the commodity, the number of items of which is changed, and result data representing the number of items after the change to the mobile controller 3.

In the mobile controller 3, the processor 31 transfers the request for the quantity change in ACT 219 and thereafter proceeds to ACT 220.

In ACT 220, the processor 31 acquires the result data transmitted from the virtual POS server 2 as explained above. The processor 31 may save the acquired result data in the main memory 32 or the auxiliary storage unit 33.

In ACT 221, the processor 31 updates the registration database DB32 based on the result data. That is, the processor 31 finds out registration data including the notified commodity code from the data record DR2 correlated with the transaction set as the processing target. The processor 31 rewrites the number of items included in the registration data to the number of items included in the result data.

The processor 31 may save the specifying data and the number of items sent by the request data for the quantity change in the main memory 32 or the auxiliary storage unit 33 and rewrite, according to reception of the result data representing that the update is completed, the number of items of the registration data concerning the commodity specified by the saved specifying data to the saved number of items. In this case, in the virtual POS server 2, the processor 21 may not include the commodity code and the number of items in the result data.

In ACT 222, the processor 31 instructs the user terminal 300 to display the list screen. For example, the processor 31 transmits instruction data including identification data for identifying the display instruction for the list screen to the user terminal 300 via the intra-store communication network 7 and the access point 6. The processor 31 includes, in the instruction data, a commodity code, a commodity name, a price, and the number of items included in registration data, the cancellation flag of which is “0”, among the registration data included in the data record DR2 updated as explained above. Thereafter, the processor 31 returns to the waiting state in ACT 205 to ACT 209 in FIG. 15.

In the user terminal 300, if the selected or input number of items is zero, the processor 301 determines YES in ACT 132 in FIG. 13 and proceeds to ACT 134. If the display area of the commodity name in the list screen SC1 is left-flicked, the processor 301 determines YES in ACT 115 in FIG. 10 and proceeds to ACT 134.

In Act 134, the processor 301 causes the touch panel 304 to display a deletion screen. The deletion screen is a screen for informing the customer that the target commodity is deleted from the purchased commodities.

FIG. 27 is a diagram illustrating an example of a deletion screen SC6.

The deletion screen SC6 is a screen obtained by superimposing and displaying a window WI61 on the list screen SC1 displayed before the number of items selection screen SC4 is displayed in ACT 125. The window WI61 includes a message ME61 and buttons BU61 and BU62. The message ME61 is a character message for inquiring the customer whether to delete the target commodity from the purchased commodities. The button BU61 is a softkey for the customer to designate execution of deletion. The button BU62 is a softkey for the customer to designate cancellation of the deletion.

If executing the deletion, the customer designates the execution with predetermined operation for, for example, touching the button BU61. If cancelling the deletion, the customer designates return with predetermined operation for, for example, touching the button BU62.

In ACT 135, the processor 301 confirms whether the deletion is designated. If failing in confirming the designation, the processor 301 determines NO and proceeds to ACT 136.

In ACT 136, the processor 301 confirms whether return is designated. If failing in confirming the designation, the processor 301 determines NO and returns to Act 135.

In this way, in ACT 135 and ACT 136, the processor 301 waits for the deletion or the return to be designated.

If the return is designated as explained above, the processor 301 determines YES in ACT 136, return to ACT 112 in FIG. 10, and causes the touch panel 304 to display the list screen SC1 again. In this case, since a registration state of the purchased commodities is not changed, the processor 301 causes the touch panel 304 to display, again, the list screen SC1 in the same state as the state in which the list screen SC1 is displayed before the number of items selection screen SC4 is displayed in ACT 125.

If the execution of the deletion is designated as explained above, the processor 301 determines YES in ACT 135 and proceeds to ACT 137.

In ACT 137, the processor 301 requests the mobile controller 3 to perform deletion. The processor 301 includes, in request data to be transmitted, specifying data for specifying a commodity, deletion of which is designated.

In the mobile controller 3, if the deletion is requested from the user terminal 300 as explained above, the processor 31 determines YES in ACT 207 in FIG. 15 and proceeds to ACT 223 in FIG. 17.

In ACT 223, the processor 31 transfers the request for the deletion to the virtual POS server 2 together with a notification of the transaction code of the transaction set as the processing target. At this time, the processor 31 may directly transfer, to the virtual POS server 2, the request data transmitted from the user terminal 300 or may transmit the request data after conversion by some processing to the virtual POS server 2. However, if specifying data included in the request data is not a commodity code, the processor 31 replaces the specifying data with the commodity code. In this way, the deletion target commodity is notified from the user terminal 300 to the virtual POS server 2 via the mobile controller 3. In the user terminal 300, the processor 301 executes the information processing based on the smartphone POS application AP301 in this way, whereby the computer including the processor 301 as the central part functions as a notifying unit.

In the virtual POS server 2, the processor 21 regards the request by the request data transmitted from the mobile controller 3 as a deletion instruction input by the input device included in the existing POS terminal and excludes the target commodity from the purchased commodities with the same processing as the processing by the existing POS terminal. The processor 21 transmits, to the mobile controller 3, result data representing a commodity code of the commodity excluded from the purchased commodities. The processor 21 executes the information processing based on the virtual POS application AP21 in this way, whereby the computer including the processor 21 as the central part functions as a deleting unit.

In the mobile controller 3, after transferring the request for the deletion in ACT 223, the processor 31 proceeds to ACT 224.

In ACT 224, the processor 31 acquires the result data transmitted from the virtual POS server 2 as explained above. The processor 31 saves the acquired result data in the main memory 32 or the auxiliary storage unit 33.

In ACT 225, the processor 31 updates the registration database DB32 based on the result data. That is, the processor 31 finds out registration data including the notified commodity code from the data record DR2 correlated with the transaction set as the processing target. The processor 31 changes a cancellation flag included in the registration data to “1”.

The processor 31 may save the specifying data sent by the request data for the deletion in the main memory 32 or the auxiliary storage unit 33 and change, according to reception of result data representing completion of the deletion, the cancellation flag of the registration data concerning the commodity specified by the saved specifying data. In this case, in the virtual POS server 2, the processor 21 may not include the commodity code in the result data.

In ACT 226, the processor 301 confirms whether the deleted commodity is a confirmation required commodity. The processor 301 determines YES if the deleted commodity is the confirmation required commodity and proceeds to ACT 227.

In ACT 227, the processor 301 confirms whether there is a confirmation required commodity other than the purchased commodities of the transaction set as the processing target. If there is no confirmation required commodity, the processor 301 determines NO and proceeds to ACT 228. That is, if no confirmation required commodity is included in the purchased commodities because of the commodity deletion of this time, the processor 301 proceeds to ACT 228.

In ACT 228, concerning the data record DR1 correlated with the transaction set as the processing target in the transaction management database DB31, the processor 301 changes the confirmation requirement flag set in the field F14 of the data record DR1 to “0”.

In ACT 229, the processor 31 instructs the user terminal 300 to display a list screen. For example, the processor 31 transmits instruction data including identification data for identifying the display instruction for the list screen to the user terminal 300 via the intra-store communication network 7 and the access point 6. The processor 31 includes, in the instruction data, a commodity code, a commodity name, a price, and the number of items included in registration data, the cancellation flag of which is “0”, among the registration data included in the data record DR2 updated as explained above. Thereafter, the processor 31 returns to the waiting state in ACT 205 to ACT 209 in FIG. 15. If determining NO in ACT 226 because the deleted commodity is not the confirmation required commodity and if determining YES in ACT 227 because there is another confirmation required commodity, the processor 31 returns to the waiting state in ACT 205 to ACT 209 in FIG. 15 passing ACT 228 and ACT 229.

In the user terminal 300, after requesting the quantity change in ACT 133 or after requesting the deletion in ACT 137, the processor 301 proceeds to ACT 138.

In ACT 138, the processor 301 waits for display of the list screen to be instructed. If the display of the list screen is instructed from the mobile controller 3 as explained above according to the request or the quantity change or according to the request for the deletion, the processor 301 determines YES, returns to ACT 112 in FIG. 10, and causes the touch panel 304 to display the list screen SC1 again. At this time, the processor 301 forms the list screen SC1 as a screen showing commodity names, prices, and the numbers of items of the purchased commodities included in the designation data. In this case, since the registration state of the purchased commodities is changed, the processor 301 causes the touch panel 304 to display the list screen SC1 in a state representing the purchased commodities different from the list screen SC1 displayed when the quantity change or the deletion is designated.

If desiring to cancel all of the already registered purchased commodities and stop the shopping, the customer designates a stop with predetermined operation for, for example, touching the button BU11 on the list screen SC1. According to the designation, the processor 301 determines YES in ACT 116 and proceeds to ACT 139 in FIG. 11.

In ACT 139, the processor 301 causes the touch panel 304 to display a cancellation screen. The cancellation screen is a screen for informing the customer that all of the already registered purchased commodities are cancelled. The cancellation screen may include an execution button for designating cancellation execution and a return button for designating to return to a state before the change of the number of items is designated without changing the number of items.

In ACT 140, the processor 301 confirms whether the cancellation execution is designated. If failing in confirming the designation, the processor 301 determines NO and proceeds to ACT 141.

In ACT 141, the processor 301 confirms whether return is designated. If failing in confirming the designation, the processor 301 returns to ACT 140.

In this way, in ACT 140 and ACT 141, the processor 301 waits for the cancellation execution or the return to be designated.

If continuing the shopping, the customer designates the return with predetermined operation for, for example, touching the return button on the cancellation screen. According to the designation, the processor 301 determines YES in ACT 141, returns to ACT 112 in FIG. 10, and causes the touch panel 304 to display the list screen SC1 again. In this case, since the registration state of the purchased commodities is not changed, the processor 301 causes the touch panel 304 to display, again, the list screen SC1 in the same state as the state in which the list screen SC1 is displayed before the cancellation screen is displayed.

If stopping the shopping, the customer designates the cancellation execution with predetermined operation for, for example, touching the execution button on the cancellation screen. According to the designation, the processor 301 determines YES in ACT 140 and proceeds to ACT 142.

In ACT 142, the processor 301 requests the mobile controller 3 to perform cancellation.

In the mobile controller 3, if the cancellation is requested from the user terminal 300 as explained above, the processor 31 determines YES in ACT 208 in FIG. 15 and proceeds to ACT 230 in FIG. 17.

In ACT 230, the processor 31 transfers the request for the cancellation to the virtual POS server 2 together with a notification of the transaction code of the transaction set as the processing target. At this time, the processor 31 may directly transfer, to the virtual POS server 2, the request data transmitted from the user terminal 300 or may transmit the request data after conversion by some processing to the virtual POS server 2.

In the virtual POS server 2, the processor 21 regards the request by the request data transmitted from the mobile controller 3 as a cancellation instruction input by the input device included in the existing POS terminal and excludes, with the same processing as processing by the existing POS terminal, from the purchased commodities, all commodities correlated with the notified transaction code and registered. The processor 21 transmits result data representing completion of the cancellation to the mobile controller 3.

In the mobile controller 3, after transferring the request for the deletion in ACT 230, the processor 31 proceeds to ACT 231.

In ACT 231, the processor 31 acquires the result data transmitted from the virtual POS server 2 as explained above. The processor 31 saves the acquired result data in the main memory 32 or the auxiliary storage unit 33.

In ACT 232, the processor 31 updates the registration database DB32 based on the result data. That is, concerning all the registration data included in the data record DR2 correlated with the transaction set as the processing target, the processor 31 changes the cancellation flag set to “0” to “1”.

In ACT 233, concerning the data record DR1 correlated with the transaction set as the processing target in the transaction management database DB31, the processor 301 changes the confirmation requirement flag set in the field F14 of the data record DR1 to “0”.

In ACT 234, the processor 31 notifies the cancellation to the user terminal 300. Thereafter, the processor 31 returns to the waiting state in ACT 205 to ACT 209 in FIG. 15.

In the user terminal 300, after requesting the cancellation in ACT 142, the processor 301 proceeds to ACT 143.

In ACT 143, the processor 301 waits for the cancellation to be notified from the mobile controller 3. If the cancellation is notified as explained above, the processor 301 determines YES and returns to ACT 101 in FIG. 9.

If finishing registering, as the purchased commodities, all commodities that the customer desires to purchase, the customer proceeds to settlement. At this time, the customer designates an accounting start with predetermined operation for, for example, touching the button BU13 on the list screen SC1. According to the designation, the processor 301 determines YES in ACT 117 in FIG. 10 and proceeds to ACT 144.

In ACT 144, the processor 301 requests the mobile controller 3 to perform accounting.

In the mobile controller 3, if the accounting is requested from the user terminal 300 as explained above, the processor 31 determines YES in ACT 209 in FIG. 15 and proceeds to ACT 235 in FIG. 18.

In ACT 235, the processor 31 confirms whether the confirmation requirement flag set in the field F14 of the data record DR1 correlated with the transaction set as the processing target in the transaction management database DB31 is “1”. That is, the processor 31 confirms whether a confirmation required commodity is included in the purchased commodities. If the confirmation requirement flag is “1”, that is, if the confirmation required commodity is included in the purchased commodities, the processor 31 determines YES and proceeds to ACT 236. In the following explanation, a state in which the confirmation required commodity is included in the purchased commodities and permission of sales of the confirmation required commodity is not confirmed by a store clerk is referred to as confirmation required state.

In ACT 236, the processor 31 instructs the user terminal 300 to display a confirmation screen.

In the user terminal 300, after requesting the accounting in ACT 144 in FIG. 10, the processor 301 proceeds to ACT 145.

In ACT 145, the processor 301 confirms whether display of the confirmation screen is instructed. If failing in confirming the instruction, the processor 301 determines NO and proceeds to ACT 146.

In ACT 146, the processor 301 confirms whether display of an accounting screen is instructed. If failing in confirming the instruction, the processor 301 determines NO and returns to ACT 145.

In this way, in ACT 145 and ACT 146, the processor 301 waits for the display of the confirmation screen or the accounting screen to be instructed. If the display of the confirmation screen is instructed from the mobile controller 3 as explained above, the processor 301 determines YES in ACT 145 and proceeds to ACT 147 in FIG. 13.

In ACT 147, the processor 301 displays a confirmation screen. The confirmation screen is a screen for urging the customer to make contact with a store clerk in order to confirm a confirmation required commodity.

FIG. 28 is a diagram illustrating an example of a confirmation screen SC7.

The confirmation screen SC7 is a screen obtained by superimposing and displaying a window WI71 on the list screen SC1 displayed immediately before the screen is displayed. The window WI71 includes a message ME71 and buttons BU71 and BU72. The message ME71 is a character message representing that it is necessary to make contact with a store clerk in order to confirm a confirmation required commodity. The button BU71 is a softkey for the customer to designate confirmation by a store clerk. The button BU72 is a softkey for the customer to designate return to the commodity registration.

If determining to receive the confirmation by a store clerk, the customer designates the confirmation with predetermined operation for, for example, touching the button BU71. If determining to once cancel the accounting and return to the commodity registration, the customer designates return with predetermined operation for, for example, touching the button BU72.

In ACT 148 in FIG. 13, the processor 301 confirms whether the confirmation is designated. If failing in confirming the designation, the processor 301 determines NO and proceeds to ACT 149.

In ACT 149, the processor 301 confirms whether the return is designated. If failing in confirming the designation, the processor 301 determines NO and returns to ACT 148.

In this way, in ACT 148 and ACT 149, the processor 301 waits for the confirmation or the return to be designated. If the confirmation is designated as explained above, the processor 301 determines YES in ACT 148 and proceeds to ACT 150.

In ACT 150, the processor 301 causes the touch panel 304 to display a release screen. The release screen is a screen for causing the user terminal 300 to read a barcode for a store clerk, who confirms that sales of the confirmation required commodity is permitted, to release a confirmation waiting state.

FIG. 29 is a diagram illustrating an example of a release screen SC8.

The release screen SC8 includes a display area AR81, a message ME81, and a button BU81. An image obtained by the camera 305 is displayed in the display area AR81. The message ME81 is a character message for urging the store clerk to read a barcode for releasing the confirmation required state. The button BU81 is a softkey for the customer or the store clerk to declare that scan of the barcode for releasing is stopped.

For example, the processor 301 starts the camera 305, superimposes, on an image thereby obtained by the camera 305, a line representing a range of the display area AR81 and an image representing the message ME81 and the button BU81, and generates the release screen SC8.

The customer requests the store clerk to perform confirmation. The store clerk conforms whether sales of a confirmation required commodity is permitted. If the sales of the confirmation required commodity is permitted, the store clerk holds a barcode for release over the camera 305 such that the barcode for release is reflected in the display area AR81. For this work, the store clerk carries a card or the like on which the barcode for release is printed. Alternatively, for example, the store clerk causes a screen of an information terminal carried by the store clerk to display the barcode for release. As the barcode for release, a different barcode for release is preferably used for each of stores or each of companies. However, the same barcode for release is permitted to be used in different stores or different companies. By changing a regular barcode for release, for example, every day, it is possible to prevent wrongdoings if the barcode for release is acquired by the customer because of some reason.

If confirming that the sales of the confirmation required commodity is not permitted, the store clerk designates return to the commodity registration with predetermined operation for, for example, touching the button BU81. Alternatively, if determining to return to the commodity registration without requesting the store clerk to perform the confirmation, the store clerk designates the return to the commodity registration with predetermined operation for, for example, touching the button BU81.

In ACT 151, the processor 301 confirms whether the barcode is read. At this time, the processor 301 analyzes an image obtained by the camera 305 and attempts to read the barcode. The barcode reading may be performed as processing based on the smartphone POS application AP301 or may be performed as processing based on another application program for barcode reading. If failing in reading the barcode, the processor 301 determines NO and proceeds to ACT 152.

In ACT 152, the processor 301 confirms whether the return is designated. If failing in confirming the designation, the processor 301 determines NO and returns to ACT 151.

In this way, in ACT 151 and ACT 152, the processor 301 waits for the barcode to be read or the return to be designated.

If the return is designated as explained above, the processor 301 determines YES in ACT 152 and proceeds to ACT 153. In a state in which the confirmation screen SC7 is displayed on the touch panel 304, if the return is designated as explained above, the processor 301 determines YES in ACT 149 and proceeds to ACT 153.

In ACT 153, the processor 301 requests the mobile controller 3 to return to the commodity registration. The processor 301 returns to ACT 112 in FIG. 10.

In the mobile controller 3, after designating the display of the confirmation screen in ACT 236 in FIG. 18, the processor 31 proceeds to ACT 237.

In ACT 237, the processor 31 confirms whether release is requested. If failing in confirming the request, the processor 31 determines NO and proceeds to ACT 238.

In ACT 238, the processor 31 confirms whether return is requested. If failing in confirming the request, the processor 31 determines NO and returns to ACT 237.

In this way, in ACT 237 and ACT 238, the processor 31 waits for the release or the return to be requested. If the return to the commodity registration is requested from the user terminal 300 as explained above, the processor 31 determines YES in ACT 238 and returns to the waiting state in ACT 205 to ACT 209 in FIG. 15.

That is, both of the mobile controller 3 and the user terminal 300 return to the state in which the commodity registration is performed.

On the other hand, in the user terminal 300, if the barcode is reflected in the image photographed by the camera 305, the processor 301 determines YES in ACT 151 in FIG. 13 and proceeds to ACT 154.

In ACT 154, the processor 301 saves barcode data represented by the read barcode in the main memory 302 or the auxiliary storage unit 303.

In ACT 155, the processor 301 requests the mobile controller 3 to release the confirmation required state. The processor 301 includes the saved barcode data in request data to be transmitted. The processor 301 includes, in the request data to be transmitted, authentication data included in the check-in data saved in ACT 107 in FIG. 9.

If the release is requested from the user terminal 300 to the mobile controller 3 in this way, in the mobile controller 3, the processor 31 determines YES in ACT 237 in FIG. 18 and proceeds to ACT 239.

In ACT 239, the processor 31 performs authentication processing. For example, the processor 31 extracts the barcode data and the authentication data from the request data and saves the barcode data and the authentication data in the main memory 32 or the auxiliary storage unit 33. The authentication processing is processing for confirming, based on the barcode data and the authentication data acquired in this way, whether the read barcode is a regular barcode for release. The authentication processing can be performed according to any one of the following.

(1) If the barcode data and the authentication data coincide, the processor 31 determines that the regular barcode for release is read.

(2) The processor 31 processes the barcode data according to a predetermined algorithm and, if data obtained as a result of the processing and the authentication data coincide, determines that the regular barcode for release is read.

(3) The processor 31 processes the authentication data according to a predetermined algorithm and, if data obtained as a result of the processing and the barcode data coincide, determines that the regular barcode for release is read.

(4) The processor 31 processes the barcode data according to a predetermined first algorithm and processes the authentication data according to a predetermined second algorithm. If two data obtained as a result of the processing coincide with each other, the processor 31 determines that the regular barcode for release is read.

Besides, any processing for confirming that the barcode data and the authentication data are in a predetermined relation can be applied. If succeeding in confirming that the barcode data and the authentication data are in the predetermined relation, the processor 31 only has to determine that the regular barcode for release is read.

In ACT 240, the processor 31 confirms whether the processor 31 succeeds in the authentication. If the failing in the authentication, the processor 31 determines NO and proceeds to ACT 241.

In ACT 241, the processor 31 instructs the user terminal 300 to display a warning screen. Thereafter, the processor 31 returns to the waiting state in ACT 237 and the ACT 238.

In the user terminal 300, after requesting the release in ACT 155 in FIT. 13, the processor 301 proceeds to ACT 156.

In ACT 156, the processor 301 confirms whether the display of the warning screen is instructed. If failing in confirming the instruction, the processor 301 determines NO and proceeds to ACT 157.

In ACT 157, the processor 301 confirms whether display of an accounting screen is instructed. If failing in confirming the instruction, the processor 301 determines NO and returns to ACT 156.

In this way, in ACT 156 and ACT 157, the processor 301 waits for the display of the warning screen or the accounting screen to be instructed. If the display of the warning screen is instructed from the mobile controller 3 as explained above, the processor 301 determines YES in ACT 156 and proceeds to ACT 158.

In ACT 158, the processor 301 causes the touch panel 304 to display the warning screen. The warning screen is a screen for warning the store clerk that the barcode for release, which the store clerk causes the information terminal to read, is incorrect.

FIG. 30 is a diagram illustrating an example of a warning screen SC9.

The warning screen SC9 is a screen obtained by superimposing and displaying a window WI91 on the release screen SC8 displayed immediately before the screen is displayed. The window WI91 includes a message ME91 and a button BU91. The message ME91 is a character message representing that the read barcode is incorrect. The button BU91 is a softkey for the store clerk to declare that informing on the warning screen SC9 is confirmed.

If display cancellation for the warning screen SC9 is instructed by predetermined operation such as a touch on the button BU91 displayed on the warning screen SC9, the processor 301 returns to ACT 150.

In the mobile controller 3, if succeeding in the authentication as a result of the authentication processing in ACT 239 in FIG. 18, the processor 31 determines YES in ACT 240 and proceeds to ACT 242. If the confirmation requirement flag is “0”, the processor 31 determines NO in ACT 235 and proceeds to ACT 242.

In ACT 242, the processor 31 instructs the user terminal 300 to display the accounting screen. Thereafter, the processor 31 starts processing explained below in order to cause the virtual POS server 2 or the accounting machine 5 to settle a price of the commodities registered as the purchased commodities. That is, if the acquired barcode data is release data serving as data in a predetermined relation with the authentication data, the processor 31 permits a start of settlement processing.

If the processor 31 determines NO in ACT 235 and proceeds to ACT 242, since the ACT 236 is passed, the display of the confirmation screen is not instructed to the user terminal 300. Accordingly, when the processor 31 instructs the display of the accounting screen in ACT 242, in the user terminal 300, the processor 301 is in the waiting state in ACT 145 and ACT 146 in FIG. 10. Accordingly, the processor 301 determines YES in ACT 146 according to the display instruction for the accounting screen and proceeds to ACT 159 in FIG. 14.

If the processor 31 determines YES in ACT 240 and proceeds to ACT 242, when the processor 31 instructs the display of the accounting screen in ACT 242, in the user terminal 300, the processor 301 is in the waiting state in ACT 156 and ACT 157 in FIG. 13. Accordingly, the processor 301 determines YES in ACT 157 according to the display instruction for the accounting screen and proceeds to ACT 159 in FIG. 14.

In ACT 159, the processor 301 causes the touch panel 304 to display the accounting screen. The accounting screen is a screen for the customer to select in which of the user terminal 300 and the accounting machine 5 operation for settlement of a price is performed.

FIG. 31 is a diagram illustrating an example of an accounting screen SC10.

The accounting screen SC10 includes a display area AR101, a message ME101, and buttons BU101 and BU102. A total number of purchased commodities and a total amount of prices of the purchased commodities are displayed in the display area AR101. The message ME101 is a character message for urging the customer to designate in which of the user terminal 300 and the accounting machine 5 the operation for settlement of a price is performed. The button BU101 may be a softkey for the customer to designate the user terminal 300. The button BU102 may be a softkey for the user to designate the accounting machine 5.

If desiring to perform the operation for settlement of a price in the user terminal 300, the customer designates the user terminal 300 with predetermined operation for, for example, touching the button BU101. If desiring to perform the operation for settlement of a price in the accounting machine 5, the customer designates the accounting machine 5 with predetermined operation for, for example, touching the button BU102.

In ACT 160, the processor 301 confirms whether the user terminal 300 is designated. If failing in confirming the designation, the processor 301 determines NO and proceeds to ACT 161.

In ACT 161, the processor 301 confirms whether the accounting machine 5 is designated. If failing in confirming the designation, the processor 301 determines NO and returns to ACT 160.

In this way, in ACT 160 and ACT 161, the processor 301 waits for the user terminal 300 or the accounting machine 5 to be designated. If the user terminal 300 is designated as explained above, the processor 301 determines YES in ACT 160 and proceeds to ACT 162.

In ACT 162, the processor 301 requests the mobile controller 3 to perform settlement. The processor 301 includes, in request data for requesting settlement, settlement data such as a credit number or a user code for an online settlement service necessary for the settlement.

If the accounting machine 5 is designated as explained above, the processor 301 determines YES in ACT 161 and proceeds to ACT 163.

In ACT 163, the processor 301 causes the touch panel 304 to display an accounting barcode screen. The accounting barcode screen is a screen showing an accounting barcode representing data necessary for the accounting machine 5 to acquire data concerning content of a transaction from the virtual POS server 2. Although illustration of detailed processing is omitted, the processor 301 acquires an accounting barcode from the virtual POS server 2 via the mobile controller 3 and displays the accounting barcode on the accounting barcode screen.

The customer causes a scanner included in the accounting machine 5 not used by other customers to read the accounting barcode. According to the reading of the accounting barcode, the accounting machine 5 acquires, according to the data represented by the accounting barcode, data concerning the content of the transaction from the virtual POS server 2 and executes processing for settling a settlement amount calculated based on the data. If the settlement is completed, the accounting machine 5 notifies the virtual POS server 2 to that effect. In the virtual POS server 2, if the settlement completion is notified from the accounting machine 5, the processor 21 notifies the settlement completion to the mobile controller 3. The settlement completion in the accounting machine 5 may be directly notified from the accounting machine 5 to the mobile controller 3.

In the mobile controller 3, after instructing the display of the accounting screen in ACT 242 in FIG. 18, the processor 31 proceeds to ACT 243.

In ACT 243, the processor 31 confirms whether settlement is requested. If failing in confirming the request, the processor 31 determines NO and proceeds to ACT 244.

In ACT 244, the processor 31 confirms whether the settlement completion is notified. If failing in confirming the request, the processor 31 determines NO and returns to ACT 243.

In this way, in ACT 243 and ACT 244, the processor 31 waits for the settlement request or the settlement completion notification. If the settlement is requested from the user terminal 300 as explained above, the processor 31 determines YES in ACT 243 and proceeds to ACT 245.

In ACT 245, the processor 31 transfers the request for the settlement to the virtual POS server 2 together with a notification of the transaction code of the transaction set as the processing target. At this time, the processor 31 may directly transfer, to the virtual POS server 2, request data transmitted from the user terminal 300 or may transmit the request data after conversion by some processing to the virtual POS server 2.

In the virtual POS server 2, the processor 21 regards the request by the request data transmitted from the mobile controller 3 as a settlement instruction input by the input device included in the existing POS terminal, calculates, with the same processing as processing by the existing POS terminal, a price concerning the transaction identified by the notified transaction code, and performs processing for settling the price based on the settlement data. The processing for the settlement includes, for example, a settlement request to a not-illustrated settlement server. The processor 21 transmits result data representing the completion of the settlement to the mobile controller 3.

In the mobile controller 3, after transferring the request for the settlement in ACT 245, the processor 31 proceeds to ACT 246.

In ACT 246, the processor 31 waits for the settlement completion to be notified from the mobile controller 3. If the result data representing the completion of the settlement transmitted by the mobile controller 3 as explained above is received by the communication interface 34, the processor 31 determines YES and proceeds to ACT 247. If the settlement completion in the accounting machine 5 is notified as explained above, the processor 31 determines YES in Act 244 and proceeds to ACT 247.

In ACT 247, the processor 31 notifies the settlement completion to the user terminal 300.

In the user terminal 300, after requesting the mobile controller 3 to perform the settlement in ACT 162 in ACT 14 or after displaying the accounting barcode screen in ACT 163, the processor 301 proceeds to ACT 164.

In ACT 164, the processor 301 waits for the settlement completion to be notified. If the settlement completion is notified from the mobile controller 3 as explained above, the processor 301 determines YES and proceeds to ACT 165.

In ACT 165, the processor 301 causes the touch panel 304 to display a completion screen. The completion screen is a screen for informing the customer that the settlement is completed.

If confirming the completion screen, the customer declares the confirmation with predetermined operation for, for example, touching a button displayed on the completion screen. According to the declaration, the processor 301 proceeds to ACT 166. The processor 301 may proceed to ACT 166 if an elapsed time in a state in which the completion screen is displayed reaches a predetermined time.

In ACT 166, the processor 301 causes the touch panel 304 to display a scan screen for check-out. The scan screen for check-out is a screen for reading the two-dimensional code TC2 for check-out. For example, the processor 301 starts the camera 305, superimposes, on an image thereby obtained by the camera 305, a character message for urging the customer to read the two-dimensional code TC2 and a line indicating a guide for a position above which the two-dimensional code TC2 should be held, and generates a scan screen.

If the scan screen for check-out is displayed on the touch panel 304, the customer directs the camera 305 to the two-dimensional code TC2 such that the two-dimensional code TC2 posted near the exit of the store is reflected in the scan screen.

In ACT 167, the processor 301 waits for a two-dimensional code to be read. At this time, the processor 301 repeatedly analyzes images obtained by the camera 305 and attempts to read the two-dimensional code. The two-dimensional code reading may be performed as processing based on the smartphone POS application AP301 or may be performed as processing based on another application program for two-dimensional code reading, for example. If succeeding in reading the two-dimensional code, the processor 301 determines YES and proceeds to ACT 168.

In ACT 168, the processor 301 confirms whether data represented by the read two-dimensional code is check-out data.

If the data is not the check-out data, the processor 301 determines NO and returns to ACT 167. At this time, the processor 301 may cause the touch panel 304 to display a screen for notifying the customer that a wrong two-dimensional code is read.

If succeeding in confirming that the data represented by the read two-dimensional code is the check-out data, the processor 301 determines YES in ACT 168 and proceeds to ACT 169.

In ACT 169, the processor 301 requests the mobile controller 3 to perform check-out.

In the mobile controller 3, after notifying the settlement completion in ACT 247 in FIG. 18, the processor 31 proceeds to ACT 248.

In ACT 248, the processor 31 waits for the check-out to be requested. If the check-out is requested from the user terminal 300 as explained above, the processor 31 determines YES and proceeds to ACT 249.

In ACT 249, the processor 31 executes check-out processing. The check-out processing is processing for clearing the data saved in the main memory 32 and the auxiliary storage unit 33 for the management of the transaction set as the processing target. The virtual POS server 2 may ends the processing concerning the transaction according to the completion of the settlement or may end the processing concerning the transaction according to an instruction from the mobile controller 3. In the latter case, the processor 31 gives the instruction to the virtual POS server 2 in the check-out processing. A history database representing a history of operation by the user such as wrong barcode scan is sometimes managed by the store server 1, the virtual POS server 2, or the mobile controller 3, a not-illustrated another server, or the like. In this case, in the check-out processing, the processor 31 performs processing for updating the history database to reflect a history of operation concerning the transaction of this time.

In ACT 250, the processor 31 notifies completion of the check-out to the user terminal 300. The processor 31 ends the information processing illustrated in FIGS. 15 to 18.

In the user terminal 300, after requesting the check-out in ACT 169 in FIG. 14, the processor 301 proceeds to ACT 170.

In ACT 170, the processor 301 waits for a notification of the check-out completion. If the checkout completion is notified from the mobile controller 3 as explained above, the processor 301 determines YES and proceeds to ACT 171.

In ACT 171, the processor 301 clears various data temporarily used concerning the shopping of this time such as the check-in data saved in ACT 107 in FIG. 9. Thereafter, the processor 301 returns to ACT 101 in FIG. 9.

As explained above, with the transaction processing system in this embodiment, it is possible to delete the target commodity from the purchased commodities according to any of the left-flick on the list screen SC1, selection of zero in the number of items list, and the input of “0” on the number of items input screen. In this way, the operation for designating the deletion can be performed on any of the list screen SC1, the number of items selection screen SC4, and number of items input screen SC5. Consequently, the customer desiring to cancel purchase of a commodity once registered as a purchased commodity only has to perform any optional operation among those kinds of operation. A burden on the user relating to the operation is reduced.

With the transaction processing system in this embodiment, irrespective of which of the three kinds of operation is performed, the deletion screen SC6 is displayed in the same manner. If execution of deletion is designated on the deletion screen SC6, processing is performed in the same manner in order to delete the target commodity from the purchased commodities. Accordingly, irrespective of which operation the customer performs, since the following procedure of the customer is the same, the customer only has to use operation easy to use for the user as appropriate

With the transaction processing system in at least one embodiment, it is possible to designate deletion of a purchased commodity on each of the screens that sequentially transition to the list screen SC1, the number of items selection screen SC4, and the number of items input screen SC5. Accordingly, for example, even if the screen is transitioned by mistake, it is possible to designate the deletion of the purchased commodity on the screen after the transition.

Various modified implementations of this embodiment are possible as explained below.

The processor 301 may receive, as the operation for designating the deletion, any one of right flick, upward flick, downward flick, double tap, long press, and other various kinds of operation instead of the left flick operation on the list screen SC1. If any one of a plurality of kinds of operation among these kinds of operation is performed, the processor 301 may receive the operation as the designation of the deletion.

The processor 301 may be capable of transitioning from a state in which the list screen SC1 is displayed to each of a state in which number of items selection is received on the number of items selection screen SC4 and a state in which a number of items input is received on the number of items input screen SC5, for example, proceeding to ACT 129 according to long press of the number of items area AR32 and displaying the number of items input screen SC5.

The deletion screen may be differentiated according to which operation is performed in order to designate the deletion. For example, separate deletion screens may be correlated with each of the list screen SC1, the number of items selection screen SC4, and the number of items input screen SC5 and decided in advance. The processor 301 may cause the touch panel 304 to display a deletion screen correlated with a screen on which the operation for designating the deletion is performed. For example, the processor 301 may cause the touch panel 304 to display a first deletion screen if the deletion is designated on the list screen SC1 and may cause the touch panel 304 to display the first deletion screen if the deletion is designated on the number of items selection screen SC4 or the number of items input screen SC5.

The content of the operation in the user terminal 300 may be notified to the virtual POS server 2. In the virtual POS server 2, the processor 21 may execute the processing illustrated in FIG. 13. In this case, the computer including the processor 21 as the central part has a function of a deleting unit.

The content of the operation in the user terminal 300 may be notified to the mobile controller 3. In the mobile controller 3, the processor 31 may execute the processing illustrated in FIG. 13. In this case, the computer including the processor 31 as the central part has a function of a notifying unit.

The virtual POS server 2 may exchange various data with the user terminal 300 not via the mobile controller 3. That is, for example, the function realized by the mobile controller 3 based on the registration support application AP31 may be realized by the information processing by the processor 21 in the virtual POS server 2.

Registration data equivalent to one of the data records included in the transaction database DB21 may be saved in the main memory 302 or the auxiliary storage unit 303 in the user terminal 300. The processor 301 may perform update for registration and deletion of a purchased commodity of the registration data. In this case, the computer including the processor 301 as the central part has functions of a registering unit and a deleting unit.

The user terminal 300 may be a so-called cart terminal attached to a shopping cart equipped in the store. That is, the transaction processing system may be realized as a cart POS system. Alternatively, a terminal carried by the user and a terminal attached to the shopping cart may be mixed as the user terminal 300.

Apart or all of the functions realized by the processors 11, 21, 31, 41, and 301 according to the information processing can also be realized by hardware for executing information processing not based on a program such as a logic circuit. Each of the functions explained above can also be realized by combining software control with the hardware such as the logic circuit.

The several embodiments are explained above. However, the embodiments are presented as examples and are not intended to limit the scope of the embodiments of the invention. These new embodiments can be implemented in other various forms. Various omissions, substitutions, and changes can be made without departing from the spirit of the embodiments of the invention. These embodiments and modifications of the embodiments are included in the scope and the gist of the invention and included in the inventions described in claims and the scope of equivalents of the embodiments of the inventions.

What is claimed is:

1. A transaction processing system comprising:
a terminal apparatus including a display device and an operation device; and
at least one processor configured to:
register, as purchased commodities, commodities designated by operation in the operation device; and
delete, from the purchased commodities:
in a first case in which a predetermined operation is performed in the operational device for designating one of the commodities on a list screen, in the display device, the list screen representing a list of the commodities registered as the purchased commodities by the at least one processor, wherein the commodity designated by the operation is deleted from the purchased commodities;
in a second case in which operation is performed in the operational device for selecting zero from a number of items list, the number of items list for selecting a number of items concerning one of the commodities registered as the purchased commodity by the at least one processor, the commodity, the number of items of which is selected from the number of items list, or is deleted, from the purchased commodities;
in a third case in which operation is performed in the operational device for inputting zero on an input screen for inputting a numerical value serving as the number of items concerning one of the commodities registered as the purchased commodities by the at least one processor, the commodity being one of the number of items of which is input to the input screen.

2. The system according to claim 1, further comprising a transaction processing apparatus including the at least one processor.

3. The system according to claim 2, the at least one processor configured to notify the commodity designated by the operation in the first case, notify the commodity, the number of items of which is selected from the number of items list, in the second case, or notify the commodity, the number of items of which is input to the input screen, in the third case, to the transaction processing apparatus as a deletion target, wherein
the at least one processor is configured to delete, from the purchased commodities, the commodity notified as the deletion target by the at least one processor.

4. The system according to claim 3, wherein, in the first case, the second case, or the third case, the at least one processor is configured to inform an operator that the commodity is deleted from the purchased commodities and to notify the commodity to be deleted to the transaction processing apparatus when operation for instructing execution of deletion is performed in the operation device after the informing of the deletion.

5. The system according to claim 1, wherein the terminal apparatus further includes a controller configured to cause the display device to display, when operation for designating on the list screen one of areas respectively associated with the commodities registered as the purchased commodities is performed in the operation device, the number of items list for designating shift to a number of items input in addition to selection of a number of items concerning the commodity associated with the designated area, and to cause the display device to display the input screen when the shift to the number of items input is designated in the number of items list.

6. A computer implemented method for operating a transaction processing system including a display device and an operation device, the method comprising:
deleting, from commodities registered as purchased commodities designated by operation in the operation device:
in a first case in which a predetermined operation is performed in the operational device for designating one of the commodities on a list screen, in the display device, the list screen representing a list of the commodities registered as the purchased commodities, wherein the commodity designated by the operation is deleted from the purchased commodities;
in a second case in which operation is performed in the operational device for selecting zero from a number of items list, the number of items list for selecting a number of items concerning one of the commodities registered as the purchased commodity, the commodity, the number of items of which is selected from the number of items list, or is deleted, from the purchased commodities;
in a third case in which operation is performed in the operational device for inputting zero on an input screen for inputting a numerical value serving as the number of items concerning one of the commodities registered as the purchased commodities, the commodity being one of the number of items of which is input to the input screen.

7. The method according to claim 6, further comprising:
notifying the commodity designated by the operation in the first case, notifying the commodity, the number of items of which is selected from the number of items list, in the second case, or notifying the commodity, the number of items of which is input to the input screen, in the third case, as a deletion target; and
deleting, from the purchased commodities, the commodity notified as the deletion target.

8. The method according to claim 7, wherein, in the first case, the second case, or the third case, informing an operator that the commodity is deleted from the purchased commodities and to notify the commodity to be deleted when operation for instructing execution of deletion is performed in the operation device after the informing of the deletion.

9. The method according to claim 6, further comprising:
causing the display device to display, when operation for designating on the list screen one of areas respectively associated with the commodities registered as the purchased commodities is performed in the operation device, the number of items list for designating shift to a number of items input in addition to selection of a number of items concerning the commodity associated with the designated area, and to cause the display device to display the input screen when the shift to the number of items input is designated in the number of items list.

10. A non-transitory computer readable storage medium storing computer instructions, which when executed by a computer, perform a method for operating a transaction processing system including a display device and an operation device, the method comprising:
deleting, from commodities registered as purchased commodities designated by operation in the operation device:
in a first case in which a predetermined operation is performed in the operational device for designating one of the commodities on a list screen, in the display device, the list screen representing a list of the commodities registered as the purchased commodities, wherein the commodity designated by the operation is deleted from the purchased commodities;
in a second case in which operation is performed in the operational device for selecting zero from a number of items list, the number of items list for selecting a number of items concerning one of the commodities registered as the purchased commodity, the commodity, the number of items of which is selected from the number of items list, or is deleted, from the purchased commodities;
in a third case in which operation is performed in the operational device for inputting zero on an input screen for inputting a numerical value serving as the number of items concerning one of the commodities registered as the purchased commodities, the commodity being one of the number of items of which is input to the input screen.

11. The computer readable storage medium according to claim 10, the method further comprising:
notifying the commodity designated by the operation in the first case, notifying the commodity, the number of items of which is selected from the number of items list, in the second case, or notifying the commodity, the number of items of which is input to the input screen, in the third case, as a deletion target; and
deleting, from the purchased commodities, the commodity notified as the deletion target.

12. The computer readable storage medium according to claim 11, wherein, in the first case, the second case, or the third case, informing an operator that the commodity is deleted from the purchased commodities and to notify the commodity to be deleted when operation for instructing execution of deletion is performed in the operation device after the informing of the deletion.

13. The computer readable storage medium according to claim 10, the method further comprising:
causing the display device to display, when operation for designating on the list screen one of areas respectively associated with the commodities registered as the purchased commodities is performed in the operation device, the number of items list for designating shift to a number of items input in addition to selection of a number of items concerning the commodity associated with the designated area, and to cause the display device to display the input screen when the shift to the number of items input is designated in the number of items list.
